(19) United States
(12) Patent Application Publication
(10) Pub. No.: US 2023/0036072 A1
(43) Pub. Date: Feb. 2, 2023

(54) AI-Based Method and System for Testing Chatbots

(71) Applicant: Zeyu Gao, Fremont, CA (US)

(72) Inventor: Zeyu GAO, Fremont, CA (US)

(73) Assignee: Zeyu GAO, Fremont, CA (US)

(21) Appl. No.: 17/961,449

(22) Filed: Oct. 6, 2022

Related U.S. Application Data
(63) Continuation-in-part of application No. 16/750,890, filed on Jan. 23, 2020, now abandoned.
(60) Provisional application No. 63/252,991, filed on Oct. 6, 2021.
(60) Provisional application No. 62/865,643, filed on Jun. 24, 2019.

(51) Int. Cl. G06N 5/02; G06F 16/332

(52) U.S. Cl. CPC G06N 5/022; G06F 16/3329

(57) ABSTRACT

The present invention, as a first quality validation solution for chatbots, includes a system and a method for testing chatbots especially intelligent chatbots. It is built-in with innovative testable NLP and machine learning models supporting real-time chats between clients and the system with quality evaluation metrics.

### RELATED APPLICATIONS

This application claims a benefit of the provisional patent application with the application No. 62/865,643 filed on Jun. 24, 2019, the non-provisional patent application with the application Ser. No. 16/750,890 filed on Jan. 23, 2020, and the provisional patent application with the application number 63/252,991 filed on Oct. 6, 2021.

### BACKGROUND OF THE INVENTION

### 1. Field of the Invention

The present invention belongs to a field of testing intelligent or artificial intelligence (AI) based (AI-based) chatbots of using AI-based methodology especially artificial intelligence (AI) holistic quality testing and validation solutions. More specifically the present invention belongs to a field of solutions involving AI system/software holistic quality testing and validation methodology and system for testing intelligent chat systems or AI-based chat systems, a.k.a. chatbots.

### 2. Description of the Related Art

Comparing with existing tools available for chatbot development, solutions available for testing chatbot quality is rather scarce and limited, not only in occurrences but also in capacity. Some researchers have indicated the importance of testing chatbots in all possible ways before putting them into use. However, the prior art of chatbot testing methods is lack of considerations of some important features with respect to chatbot domain knowledge, memory, chat flow pattern, and so forth. Besides, on top of testing chatbot AI functional aspects, chatbot system performance characteristics like reliability, security, accessibility, usability and more also need to be addressed, tested, and assessed. A couple of existing testing tools even require manual intervention for test script building and/or test set generation. Although, in recent years, there has been a surge of research efforts on evaluating chatbots via test models and, as a result, the prior art test models have been able to reveal various chatbot issues, there is still lack of a comprehensive test model to address special test focuses with respect to chatbot domain knowledge and memory, chat subject coverage, chat question diversity, or answer patterns (Q&A).

While researchers use various evaluation metrics to measure diverse quality parameters of given chatbots, in practice it is still necessary to establish well-defined quality validation standards and assessment criteria so that QA engineers are able to assess chatbot system quality assurance and test coverage adequacy. Adequate AI chat test models are also in need to assess chatbots' memory functions, domain-specific subjects and knowledge, AI chat flow patterns and Q&A patterns. Due to the complex nature of chatbot systems and high cost of tests, cost-effective systematic test automation tools/solutions/service platforms are in critical demand among quality/test engineers in order for large-scale data-driven quality tests and evaluation being accomplished automatically. Given high level of diversity and uncertainty in chatbot responses, optimizing chatbot testing processes via more AI-based test automation solutions is still important.

### BRIEF SUMMARY OF THE PRESENT INVENTION

The present invention, as the first quality validation solution for chatbots, proposes a solution of a method and a system for holistic quality testing and validating chatbots. Those chatbot systems under test can be with built-in innovative testable natural-language-processor (NLP), machine learning and deep learning models. Such modern chatbots can possess text-to-speech and speech-to-text functions. They may have text generation, synthesis and analysis capabilities. They may understand selected languages and diverse questions and may generate responses with diverse linguistic skills even if their responses can be non-deterministic. The complete systematic automation process of the invented solution generates quality evaluation metrics for assessing real-time user-chatbot chats not only with text, image or audio single-format input/output but also with multimedia format input/output.

The presently invented solution of method includes steps as follows:
1. chatbot AI function test modeling, model discovery, similarity analysis and quality test models recommendation;
2. AI chat testing data generation, test DB augmentation and test scripting;
3. chatbot test scripting and runner;
4. AI chat tracking and chatbot test result validation;
5. chatbot testing coverage analysis and quality evaluation;
6. AI chat quality-of-service (QoS) system assessment, prediction, and validation; and
7. a platform and/or cloud-based SaaS realizing all of the above steps.

The presently invented solution of method and system includes a complete systematic AI-powered automation implementation. Overall the present invention include an AI-based method and an AI-based system for testing intelligent chatbots. The AI-based method combines a). a process of AI-based test modeling (101), b). a process of AI-based automation (102), c). a process of AI-based quality validation (103); and d). a process of forming and running an AI-based platform (104). The AI-based system for testing intelligent chatbots combines a). an engine of AI-based test modeling, b). an engine of AI-based automation, c). an engine of AI-based quality validation; and d). an AI-based platform.

### BRIEF DESCRIPTION OF THE DRAWINGS

FIG. 1 illustrates an AI-based testing method (100) in the present invention for testing chatbots especially intelligent chatbots aka AI-based chatbots or AI-powered chatbots, combing a process of AI-based test modeling (101), a process of AI-based automation (102), a process of AI-based quality validation (103), and a process of forming and running a platform (104).

FIG. 2 illustrates a flow diagram for AI-based test modeling for testing intelligent chatbots.

FIG. 3 illustrates a modeling process (202) and its result in the present invention.

FIG. 4 illustrates a flow diagram for learning based chat test modeling (301).

FIG. 5 illustrates a flow diagram for AI-based chat test data generation and augmentation (302).

FIG. 6 shows components of test input data augmentation (503).

FIG. 7 illustrates a block diagram of an example of multi-perspective Chatbot AI function test model (303).

FIG. 8 shows components of AI function context classification (701).

FIG. 9 shows components of chat input classification (702).

FIGS. 10-13 show components of chat input classification spanning tree forest (901).

FIGS. 10 shows components of chat input classification spanning tree forest (901).

FIG. 11 illustrates a tree diagrams of domain knowledge test model (1001) and memory test model (1002).

FIG. 12 illustrates a tree diagrams of chat language test model (1003) and chat question and response test model (1004).

FIG. 13 illustrates a tree diagrams of chat flow pattern test model (1005) and subject test model (1006).

FIG. 14 shows components of AI function output classification (703).

FIG. 15 illustrates an example of multi-perspective Chatbot AI function test model (303).

FIG. 16 shows components of Ai-based automation for testing intelligent Chatbot

FIG. 17 illustrates a flow diagram of a classification-based test automation for AI functions (1606).

FIG. 18 illustrates a flow diagram of classification-based re-test automation for AI functions (1607).

FIG. 19 illustrates a flow diagram of whole process of a classification-based automation for AI functions (1608).

FIG. 20 illustrates a flow diagram of AI-based quality validation for intelligent Chatbot (103).

FIG. 21 illustrates a flow diagram of measuring AI-based test coverage analysis and complexity (2005).

FIG. 22 shows components of Chatbot test coverage analysis (2101).

FIG. 23 shows components of Chatbot quality prediction (2102).

FIG. 24 shows components of AI-based quality assessment for intelligent Chatbots (2006).

FIG. 25 shows components of quality validation approaches for testing intelligent Chatbot (2007).

FIG. 26 illustrates a flow an AI-based automatic chat test result validation process in the present invention.

FIG. 27 illustrates a step of generating a 3D classification decision table for the AI-based automatic chat test result validation process in the present invention.

FIG. 28 illustrates a process of an integrated language-based test similarity evaluation in an AI-based test result validation solution in the present invention.

FIG. 29 illustrates a process of a keyword-based weighted text similarity evaluation in an AI-based test result validation solution in the present invention.

FIG. 30 illustrates a process of an AI-based test result validation solution (#1) in the present invention.

FIG. 31 illustrates a process of a keyword-based weighted text similarity evaluation in an AI-based test result validation solution (#2) in the present invention.

FIG. 32 illustrates a process of a keyword-based weighted text similarity evaluation in an AI-based test result validation solution (#3) in the present invention.

FIG. 33 illustrates components of chatbots holistic evaluation and quality metrics (2009) in the present invention.

FIG. 34 illustrates chatbots' holistic evaluation and quality metrics and parameters (1804) in the present invention.

FIG. 35 illustrates chatbots' system and user evaluation and quality metrics and parameters (1804SU) in the present invention.

FIG. 36 illustrates chatbots' language-based automatic evaluation parameters (1804LB) in the present invention.

FIG. 37 illustrates chatbots' system cognitive evaluation metrics and parameters (1804SC) in the present invention.

FIG. 38 illustrates a process (104) for forming and running of forming and running an AI-based platform for testing intelligent chatbot in the present invention.

FIG. 39 illustrates AI-based SaaS/cloud services for testing intelligent chatbots as a part of the AI-based platform for testing intelligent chatbot in the present invention.

### DETAILED DESCRIPTION OF THE INVENTION

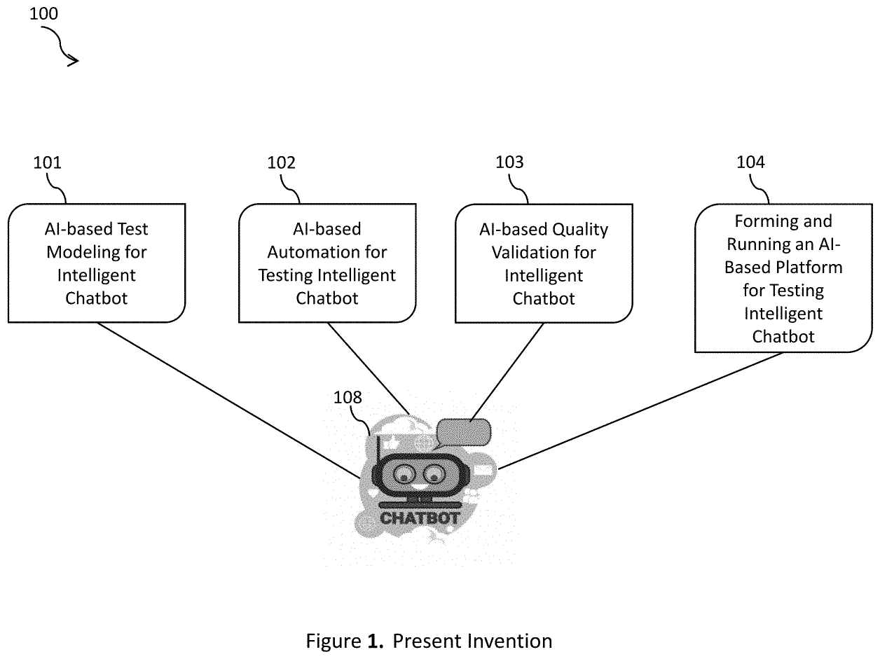

FIG. 1 illustrates a method for Chatbot-specific AI-based testing. The method consists of four components, including a process for AI-based modeling for Chatbot-specific AI-based testing (101), a process for AI-based quality validation for Chatbot-specific AI-based testing (102), a process for forming a platform for Chatbot-specific AI-based testing (103), and process for AI-based automation for Chatbot-specific AI-based testing (104).

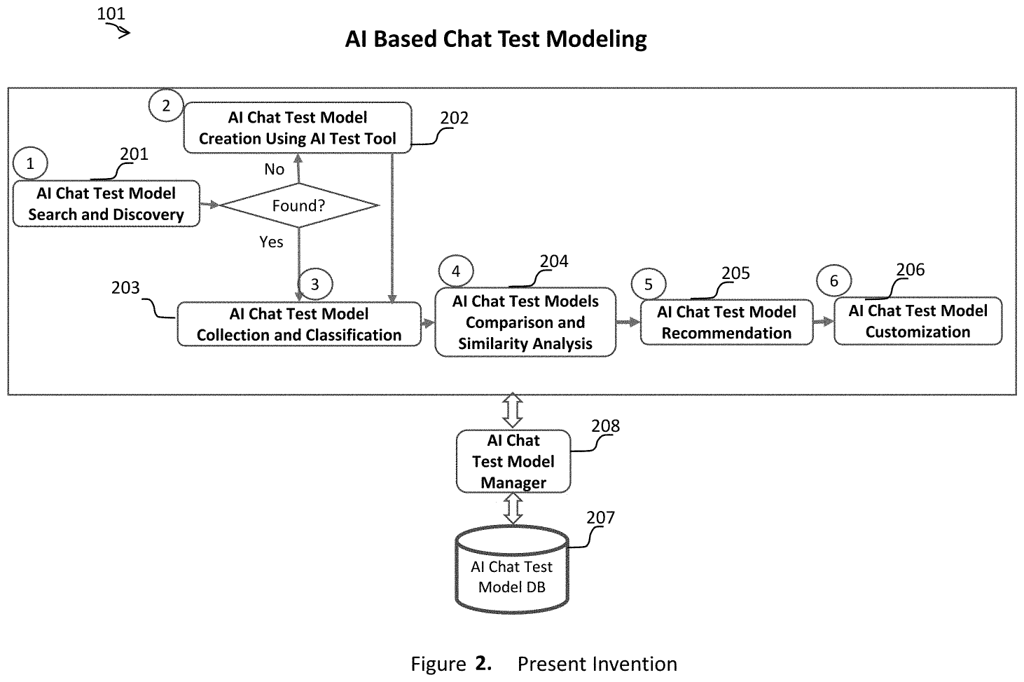

FIG. 2 illustrates a flow chart for AI-based modeling for Chatbot-specific AI based testing (101). AI-based modeling for Chatbot-specific AI based testing (101) is developed to support the following steps: AI chat test model search and discovery (201), AI Chat test model creation using AI test tool (202), AI chat test model collection and classification (203), AI chat test models comparison and similarity analysis (204), AI chat test model recommendation (205), AI chat test model customization (206), AI chat test model database (207), and AI chat test model manager (208).
a. Step 1 (201): Upon given information of Chatbot to be tested, a process conducts search and discovery of existing AI chat test models to discover the closely related AI chat test models from an AI Chat Test Model Database (507) through AI Chat Test Model Manager (508). If not found, proceed to step 2. If found, proceed to step 3.
b. Step 2 (202): If not found, then, testers can use the AI Test Tool provided to create a test model. Then proceed to step 3.
c. Step 3 (203): Then, the created or discovered model will be stored and classified in the AI Chat Test Model Database (507).
d. Step 4 (204): The stored and classified AI chat test models will then be compared with using similarity analysis.
e. Step 5 (205): Given recommendation criteria, testers conduct model recommendation based on the similarity analysis results and the provided recommendation criteria.
f. Step 6 (506)—Finally, testers will perform customization based on the 7 recommended test models and generate a desirable one for their AI chat test project.

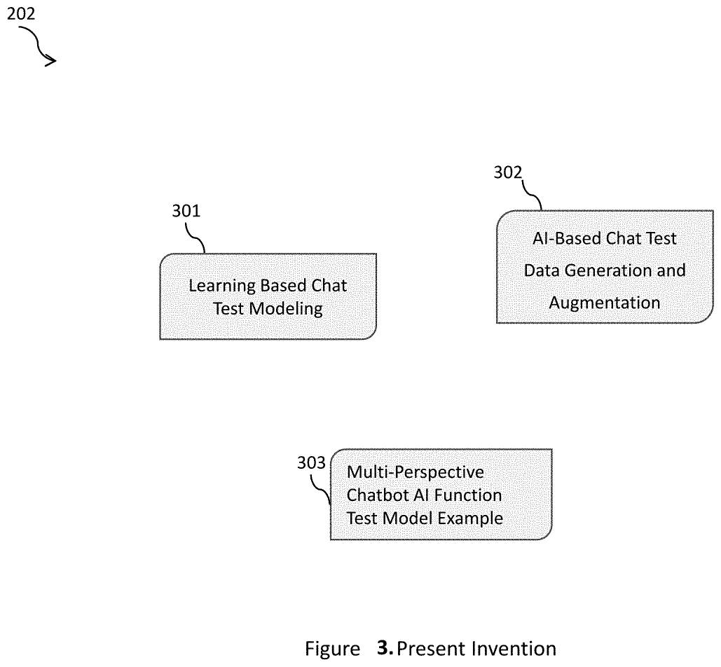

FIG. 3 illustrates the three possible components of the AI chat test model creation using AI test tool (202). It includes learning-based chat test modeling (301), AI-based chat test data generation and augmentation (302), and multi-perspective Chatbot Ai function test model example (303).

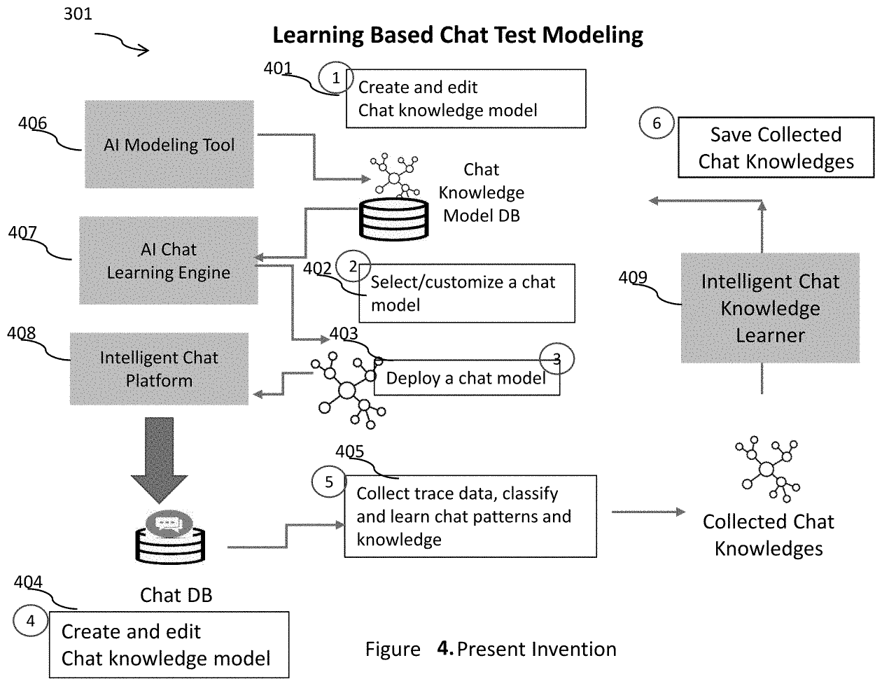

FIG. 4 illustrates a flow chat of learning-based chat test modeling (301). The process includes an AI modeling tool (406), an AI chat learning engine (407), an intelligent chat platform (408), and an intelligent chat knowledge learner (409). The steps are: to create and to edit chat knowledge model (401), to select/customize a chat model (402), to deploy a chat model (403), to create and to edit chat knowledge model (404), to collect trace data, to classify and to learn chat patterns and knowledge (405), and to save collected chat knowledge (406).
a. Step 1 (401):
Using the AI modeling tool (406) and a chat knowledge model database to create/edit the chat knowledge model; and
Storing chat knowledge model in the chat knowledge model database.
b. Step 2 (402): Using the AI chat learning engine (407) to select and to customize a chat model.
c. Step 3 (403): With the model selected and customized, deploying the chat model onto the intelligent chat platform (408).

d. Step 4 (404): On the platform, storing the selected model into the chat database and running the chat knowledge model.
e. Step 5 (405):
Collecting the result and data from running the chat knowledge model; and
Classifying and learning chat patterns and knowledge through the results.
f. Step 6 (406):
Inputting the test result and the collected chat knowledge into an intelligent chat
knowledge learner; and
Storing the collected chat knowledge.

An AI modeling tool (406) is an AI test modeling tool as a cloud-based service platform supporting diverse AI test modeling and analysis. It is used for support AI chat modeling and analysis in this process.

An AI chat learning engine (407) is an important intelligent component which has built-in and configurable intelligent chat models, including domain knowledge models, cognitive models, interaction models, and NPL models supports training, learning, and evaluation in machine learning.

An intelligent chat platform (408) is a cloud-based intelligent chat platform which supports diverse chat platform services and operations.

An intelligent chat knowledge learner (409) is an intelligent component which performs chat knowledge learning, and analysis, and discovery and generate chat knowledge graphs, and discover the similarity and differences among the models.

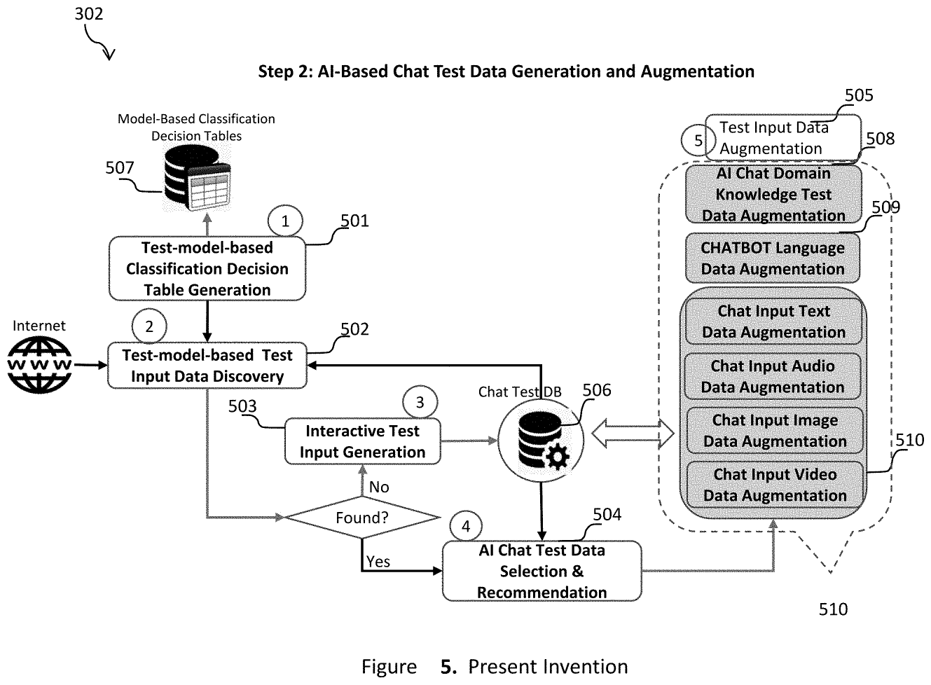

FIG. 5 shows the flow chart for AI-based chat test data generation and augmentation. The process includes model-based classification decision tables (507), Chat test database (506, and test input data augmentation (504). The process includes following steps: test-model-based classification decision table generation (501), test-model-based test input data discovery (502), interactive test input generation (503), AI chat test data selection and recommendation (504), and test input data augmentation (505).

a. Step 1 (501): Using the model-based classification decision table, generate test-model-based decision table.
b. Step 2 (502): Searching for information on internet and chat test database as input for test-model-based test. If input information is not found, proceed to step 3. If found, proceed to step 4.
c. Step 3 (503): If input information is not found, generate interactive test input and store the generated interactive test input into chat test database. Then proceed to step 4.
d. Step 4 (504): Using data stored in chat test database as input for the AI chat test. Perform data selection and recommendation for the test input.
e. Step 5 (505): Using the selected test input data for test input data augmentation. The augmentation consists of AI chat domain knowledge test data augmentation (508), Chatbot language data augmentation (509), and rich-media data augmentation (510). The rich-media data augmentation includes chat input text data augmentation, chat input audio data augmentation, chat input image data augmentation, and chat input video data augmentation.

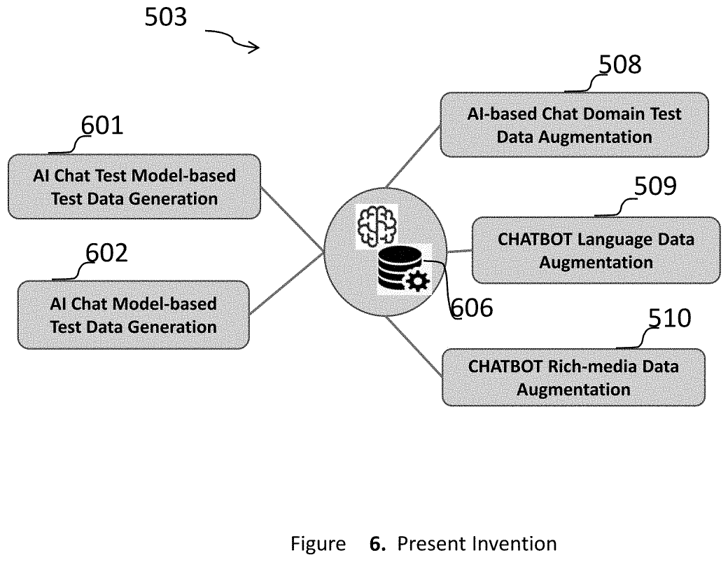

FIG. 6 shows the components of interactive test input generation.

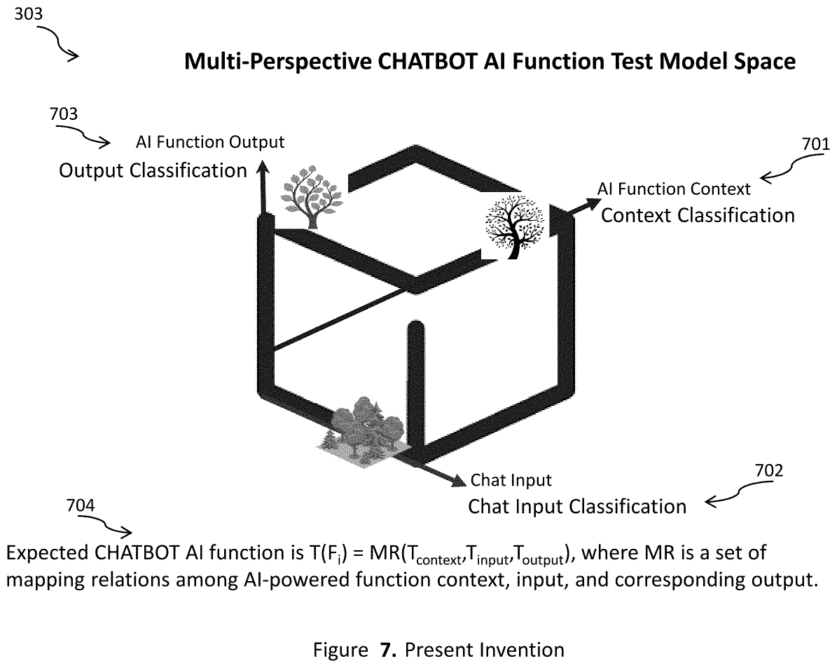

FIG. 7 shows a multi-perspective Chatbot AI function test model (303) as an example of the AI chat test model creation using AI test tool (202). The model includes three perspectives: Ai function context classification (701), chat input classification (702), and AI function output classification (703). The expected Chatbot AI function (704) is T(F,) =MR(T_{context}, Tᵢₙₚᵤₜ, Tₒᵤₜₚᵤₜ). MR is a set of mapping relations among AI-powered function context, input, and corresponding output.

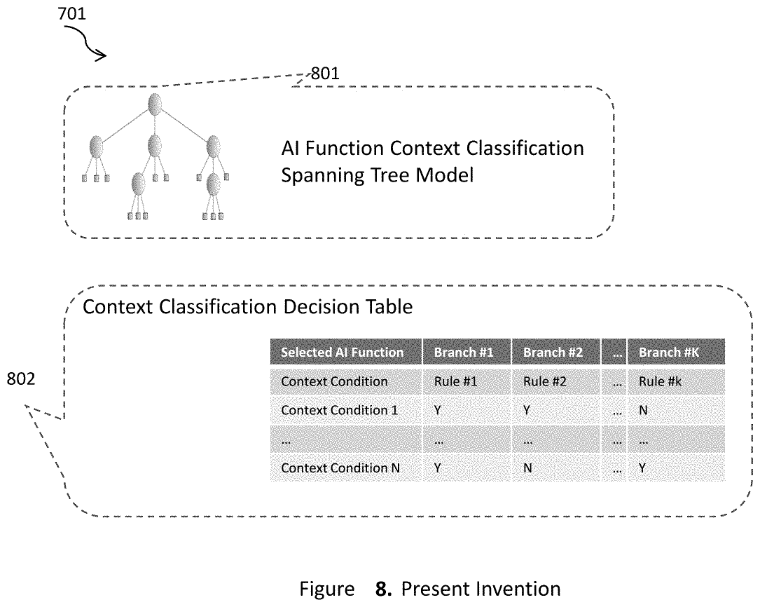

FIG. 8 shows the components of AI function context classification (701). It includes AI function context classification spanning tree model (801) and context classification decision table (802).

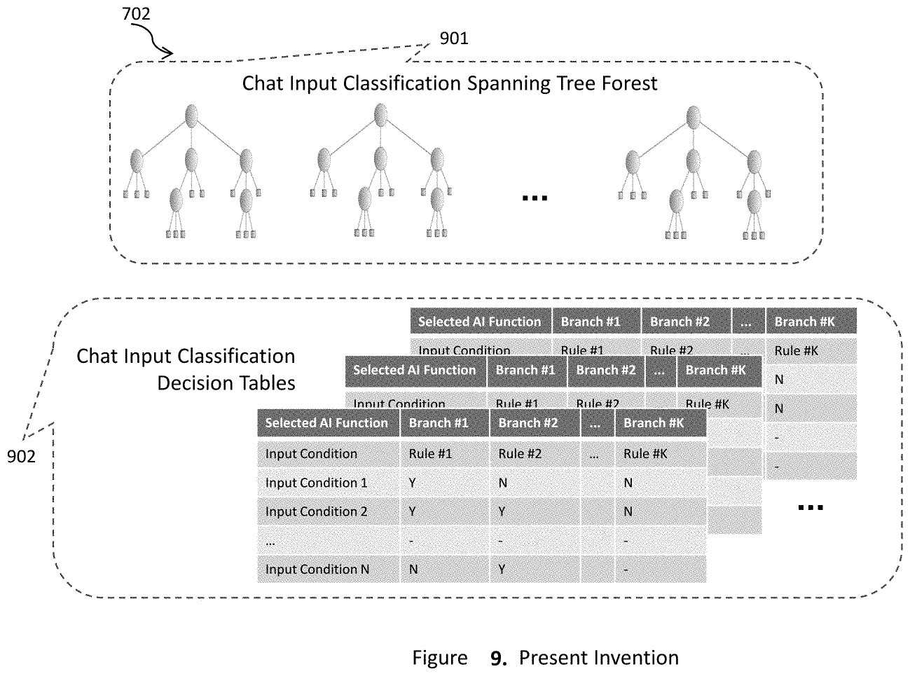

FIG. 9 shows the components of chat input classification (702). It includes chat input classification spanning tree forest (901) and chat input classification decision tables (902).

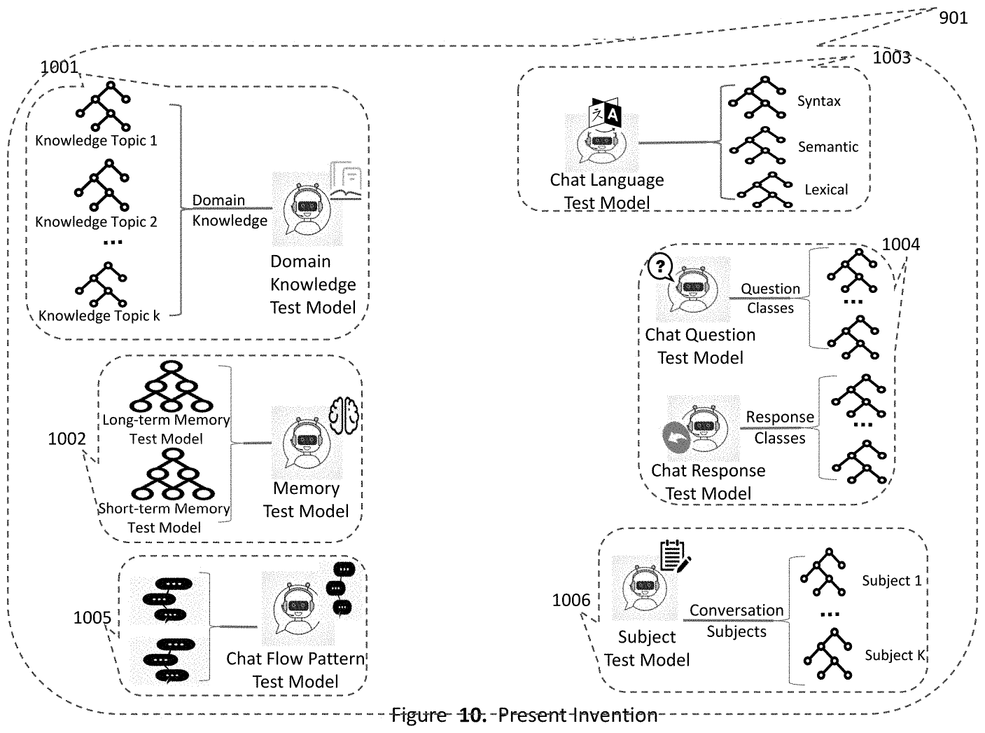

FIG. 10-13 shows the components of chat input classification spanning tree forest (901). The six-classification panning tree are as following: domain knowledge test model (1001), memory test model (1002), chat language test model (1003), chat question and response test model (1004), chat flow pattern test model (1005), and subject test model (1006).

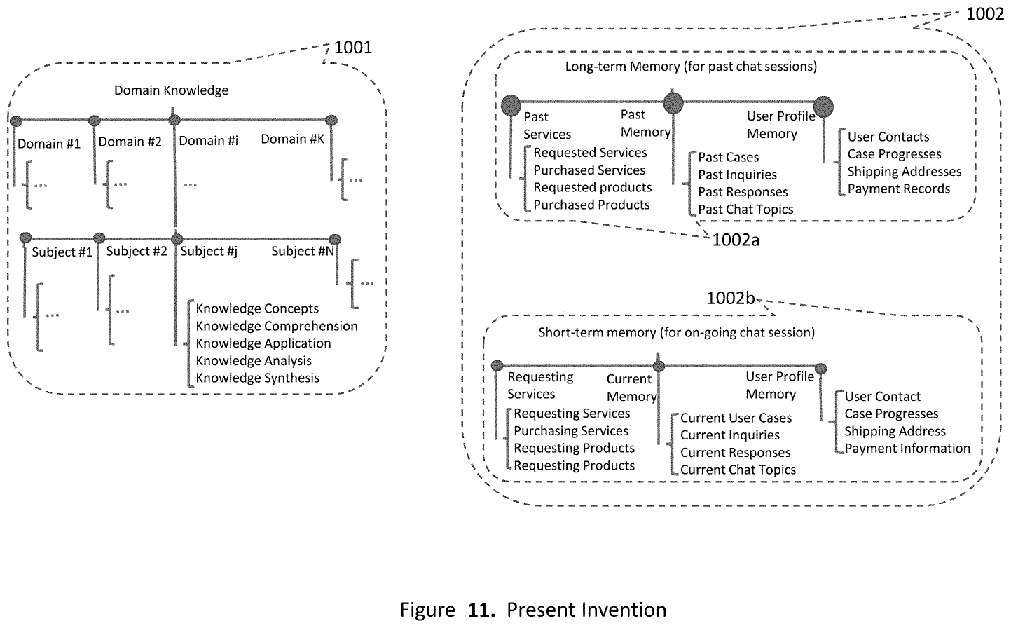

FIGS. 11 shows domain knowledge test model (1001) and memory test model (1002). Domain knowledge test model branching from domain knowledge into subject topics, within subject it includes knowledge concepts, knowledge comprehension, knowledge application, knowledge analysis, and knowledge synthesis. Memory test model (1002) includes long-term memory test model (1002a) for past chat sessions. Past memories include past service: requested services, purchased services, requested products, and purchased products; past memory including past cases, past inquiries, past responses, past chat topics; and user profile memory including user contacts, case progresses, shipping addresses, and payment records. Anther component is short-term memory (1002b) for on-going chat session. On-going memory include requesting services: requested services, purchased services, requested products, and purchased products; current memory: current user cases, current inquiries, current responses, current chat topics; user profile memory: user contacts, case progresses, shipping addresses, and payment information.

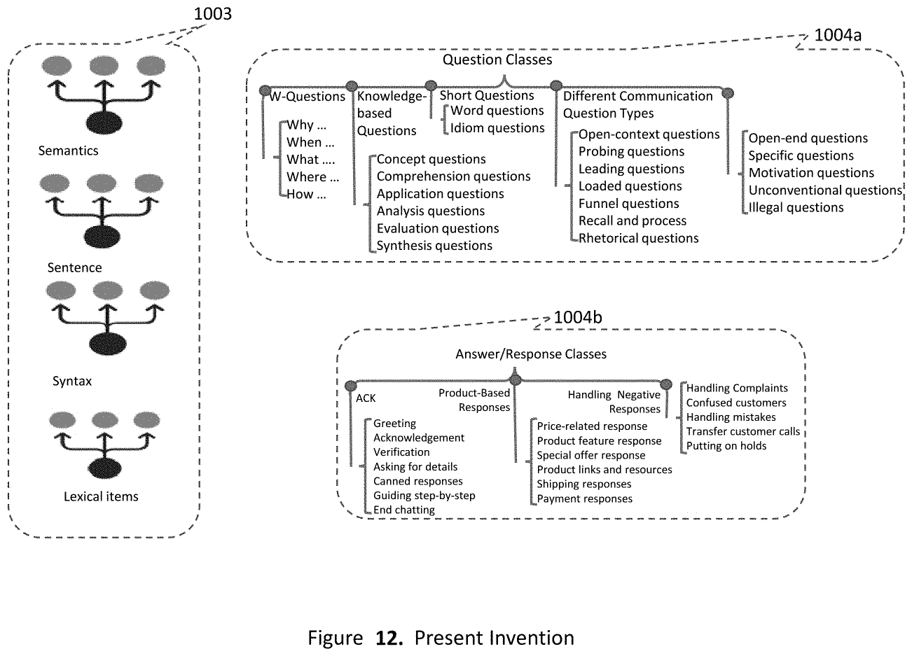

FIGS. 12 shows the tree graph for chat language test model (1003) and chat question and response test model (1004). Chat question and response test model include question classes (1004a) and answer/response classes (1004b). The chat language test model (1003) includes semantics, sentence, syntax, and lexical items. The chat question test model (1004s) includes four sections: w-questions, knowledge-based questions, short questions, different communication question types. W-questions include why, when, what, where, and how. Knowledge-based questions include concept questions, comprehension questions, application question, analysis questions, evaluation questions, and synthesis questions. Short questions include word questions and idiom questions. Different communication question types include open-context questions, probing questions, leading questions, loaded questions, funnel questions, recall and process, and rhetorical questions. Lastly the question classes include open-end questions, specific questions, motivation questions, unconventional questions, illegal questions. The chat question test model includes three sections: ACK, product-based response, and handling negative response. ACK includes greeting, acknowledgement, verification, asking for details, canned responses, guiding step-by-step, and end chatting. Product-based responses include price-related response, product feature response, special offer response, product links and resources, shipping responses, payment responses. Handling negative responses include handling complaints, confused customers, handling mistakes, transfer customer calls, and putting on holds.

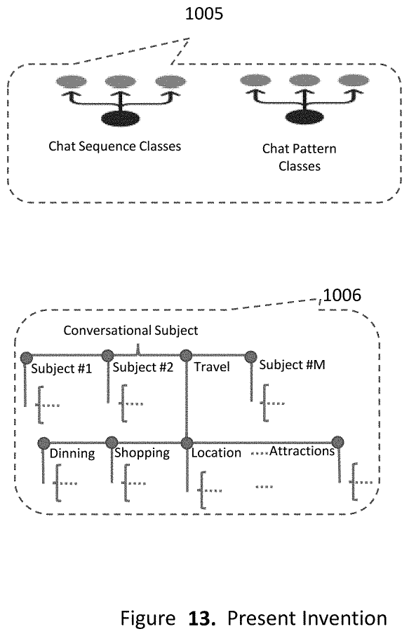

FIG. 13 shows the tree graph for chat flow pattern test model (1005) and subject test model (1006). Chat flow pattern test model includes chat sequence classes and chat pattern classes. Subject test model includes subject topics branching from conversation subject with sub-subjects like dinning, shopping, location, and attractions under subject topics.

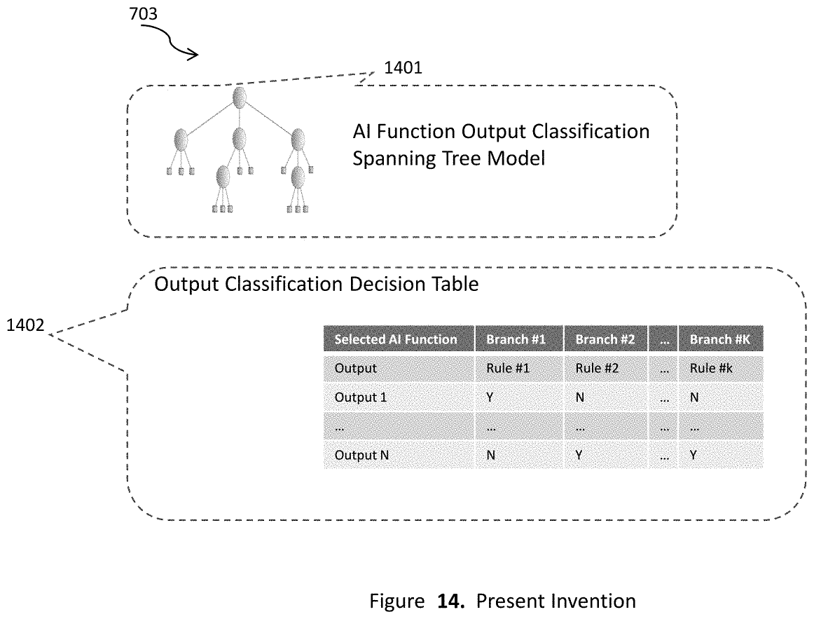

FIG. 14 shows the components of AI function output classification (703). It includes Ai function output classification spanning tree model (1401) and output classification decision table (1402).

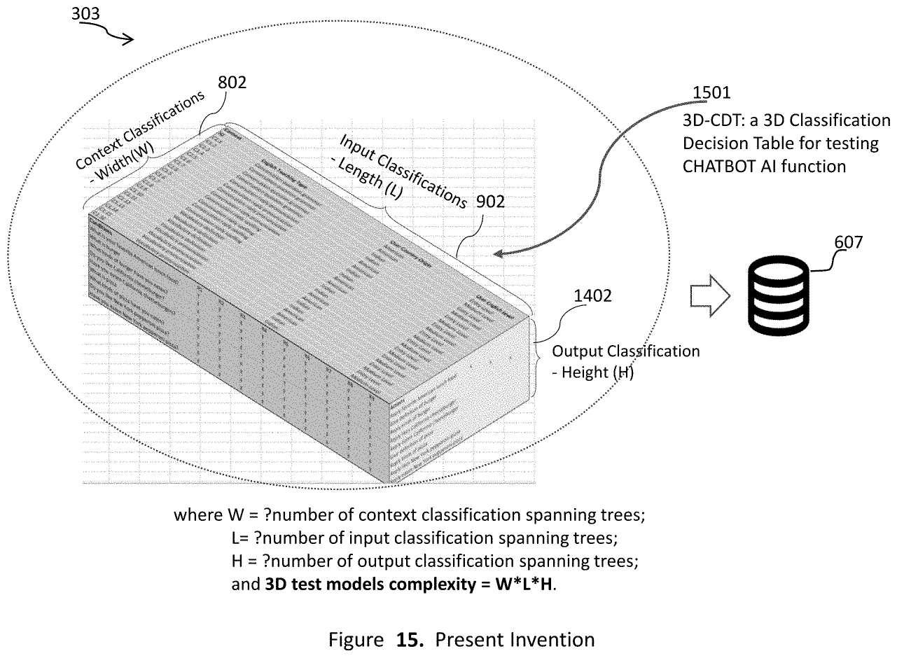

FIG. 15 illustrates an example of multi-perspective Chatbot AI function test model 12 (303). The three dimensions of the model are context classification (802) as width (W), input classification (902) as length (L), output classification (1402) as height (H). Where W=number of context classification spanning trees, L =number of input classification spanning trees, and H=number of output classification spanning trees. The 3D test model complexity=W*L*H. A 3D-CDT (1501), 3D classification decision table, for testing Chatbot AI function is used in calculating the model. The output is then stored in AI chat test model database (601).

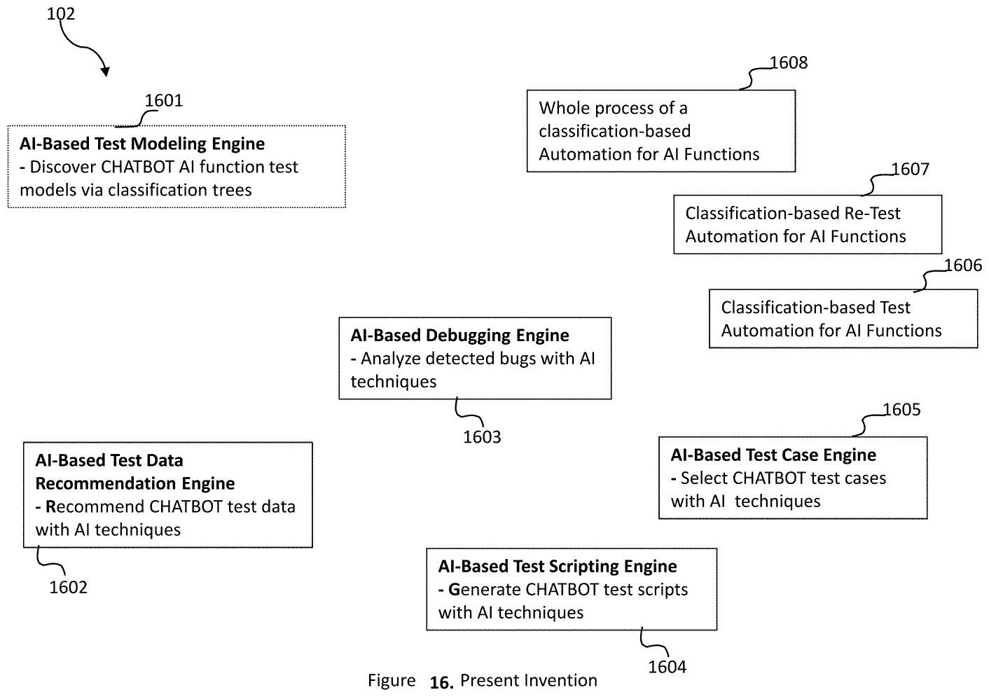

FIG. 16 shows the components of Ai-based automation for testing intelligent Chatbot (102). The AI-based automation includes AI-based test modeling engine (1601), AI-based test data recommendation engine (1602), AI-based debugging engine (1603), AI-based test scripting engine (1604), AI-based test case engine (1605), classification-based test automation for AI functions (1606), classification-based re-test automation for AI functions (1607), and whole process of a classification-based automation for AI functions (1608).
a. AI-based test modeling engine (1601) automatically discovering test models based on existing AI test models and assisting derivation of new AI test model via classification trees.
b. AI-based test data recommendation engine (1602) automatically finding most effective data with given test model and test script, recommend Chatbot test data with AI techniques.

1 c. AI-based debugging engine (1603) automatically analyzing and detecting bug and generating the detailed information of bugs.
d. AI-based test scripting engine (1604) automatically assisting on generation and derivation of new Chatbot test scripting.
e. AI-based test case engine (1605) automatically selects Chatbot test cases with AI techniques.

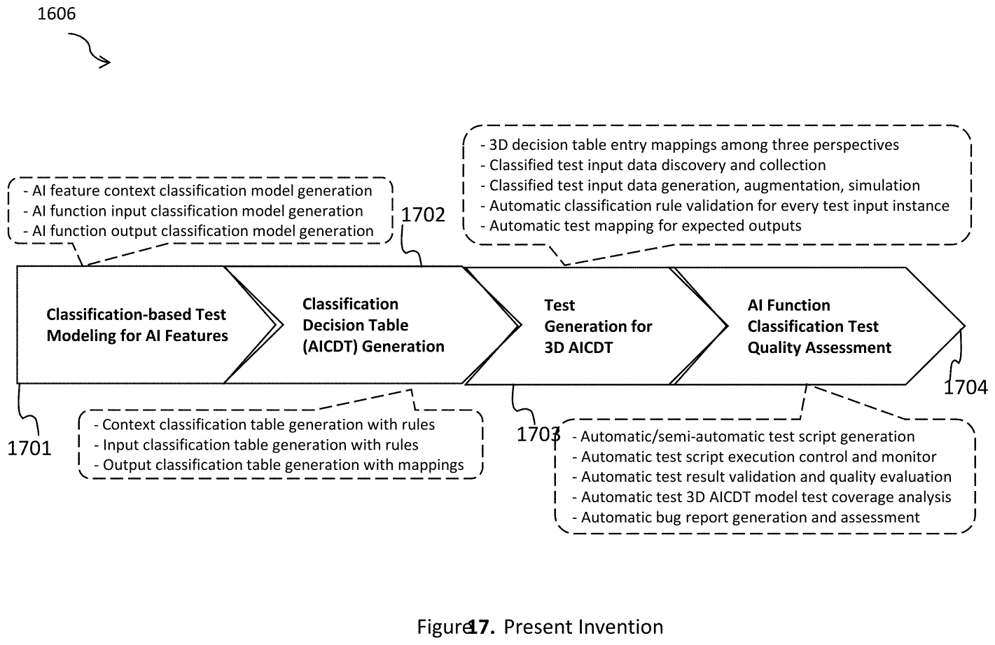

FIG. 17 illustrates a flow diagram of a classification-based test automation for AI functions (1606). The process includes four steps: classification-based test modeling for AI features (1701), classification decision table (AICDT) generation (1702), test generation for 3D AICDT (1703), and AI function classification test quality assessment (1704).
a. Step 1(1701): Automatically generates the classified test model for context, input, and output. This step generates AI feature context, input, and output classification models.
b. Step 2 (1702): Generates the classification table with rules for context, input, and output.
c. Step 3 (1703): A test generation for multi-dimension AI classification decision table automatically collects all test data and classifies test input data generation, augmentation, and simulation, then automatically validates all test input data and map for expected outputs and events.
d. Step 4 (1704): An AI function classification test quality assessment automatically generates the quality assessment which includes test script, test result validation and quality evaluation, test converge analysis, and bug report and assessment.

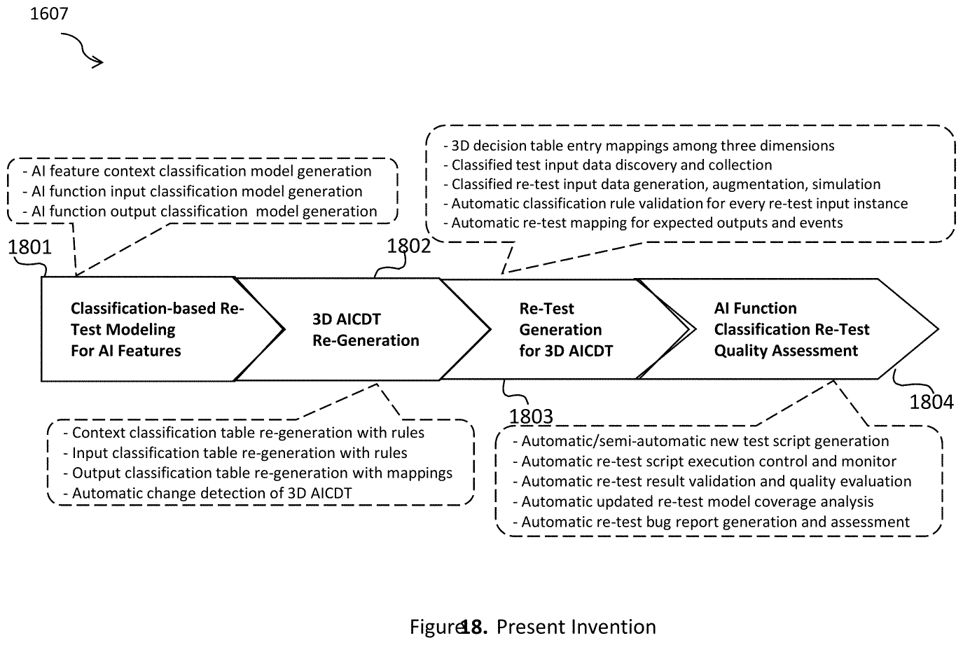

FIG. 18 illustrates a flow diagram of classification-based re-test automation for AI functions (1607). The process includes four steps: classification-based re-test modeling for AI features (1801), 3D AICDT re-generation (1802), re-test generation for 3D AICDT (1803), and AI function classification re-test quality assessment (1804).
a. Step 1 (1801): A classification-based test modeling for AI feature, it automatically re-generates the classified test model for context, input, and output.
b. Step 2 (1802): A multi-dimension AI classification decision table generation automatically re-generates the classification table with rules for context, input, and output.
c. Step 3 (1803): A test generation for AI classification decision table automatically re-collects all test data and re-classifies test input data generation, augmentation, and simulation, then re-validates all test input data and re-map for expected outputs and events.
d. Step 4 (1804): an AI function classification test quality assessment automatically re-generates the quality assessment which includes re-tested test script, re-tested test result validation and quality evaluation, re-tested test converge analysis, and re-tested bug report and assessment.

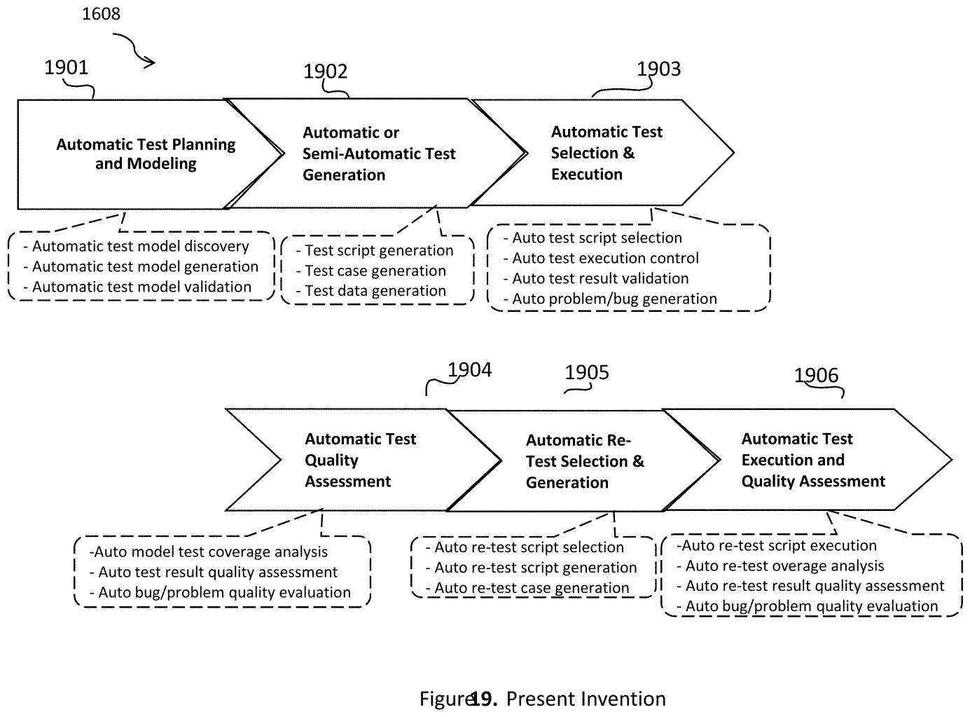

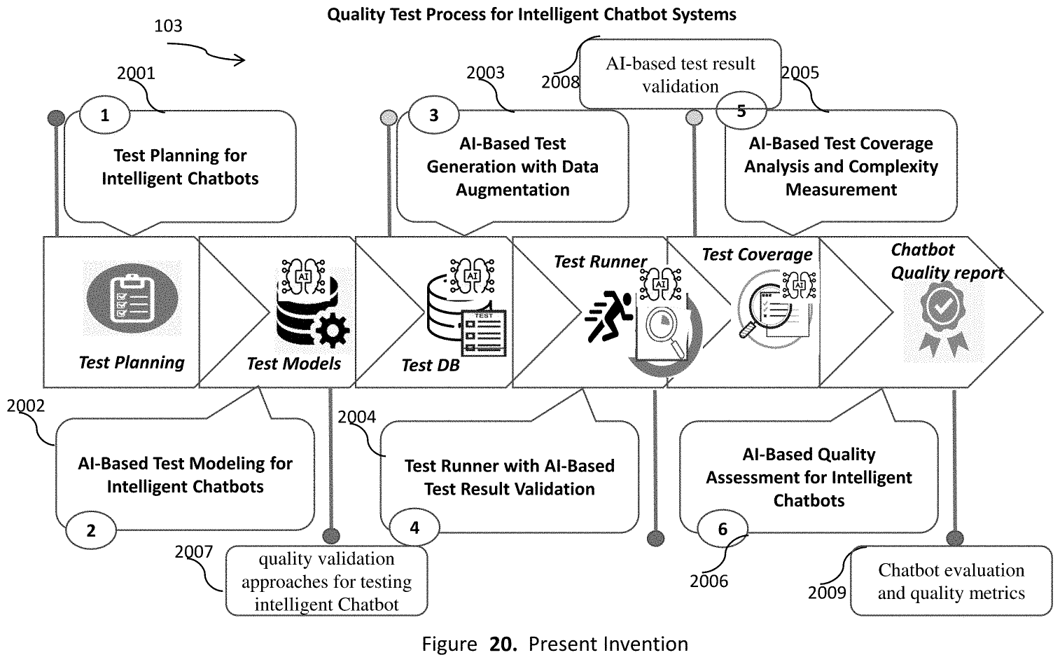

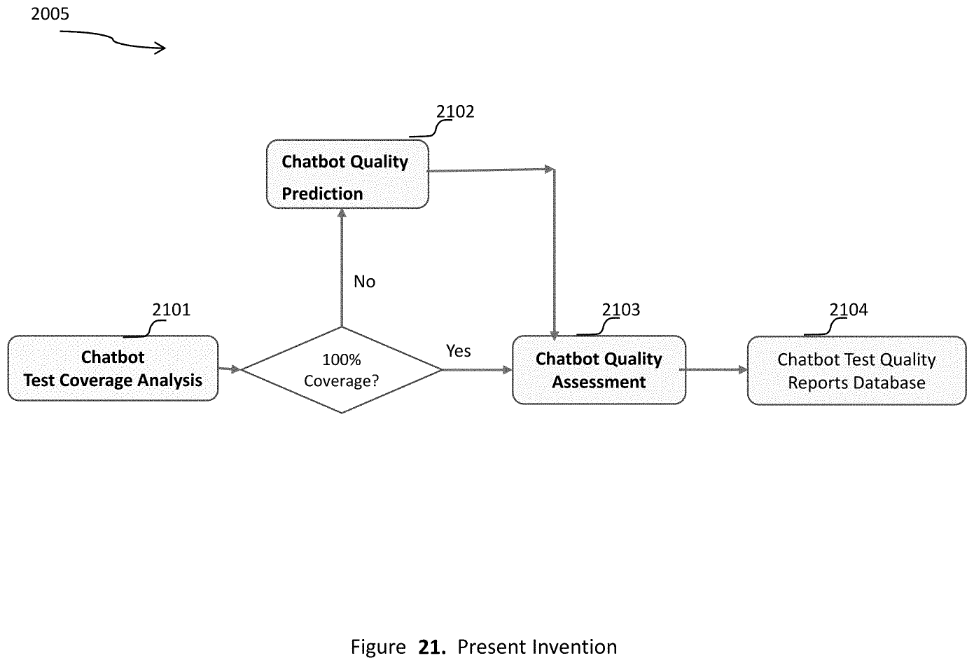

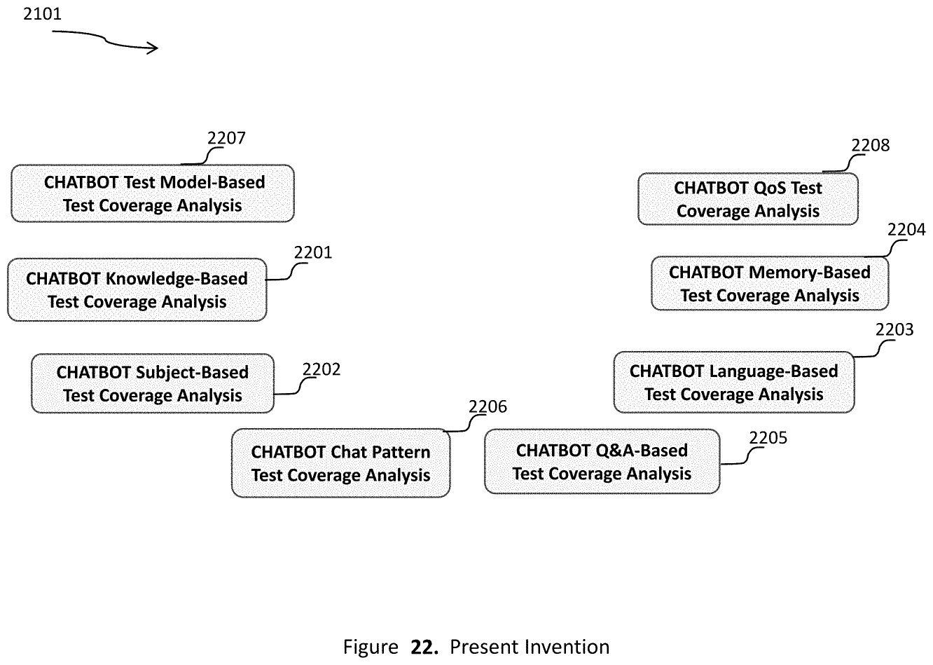

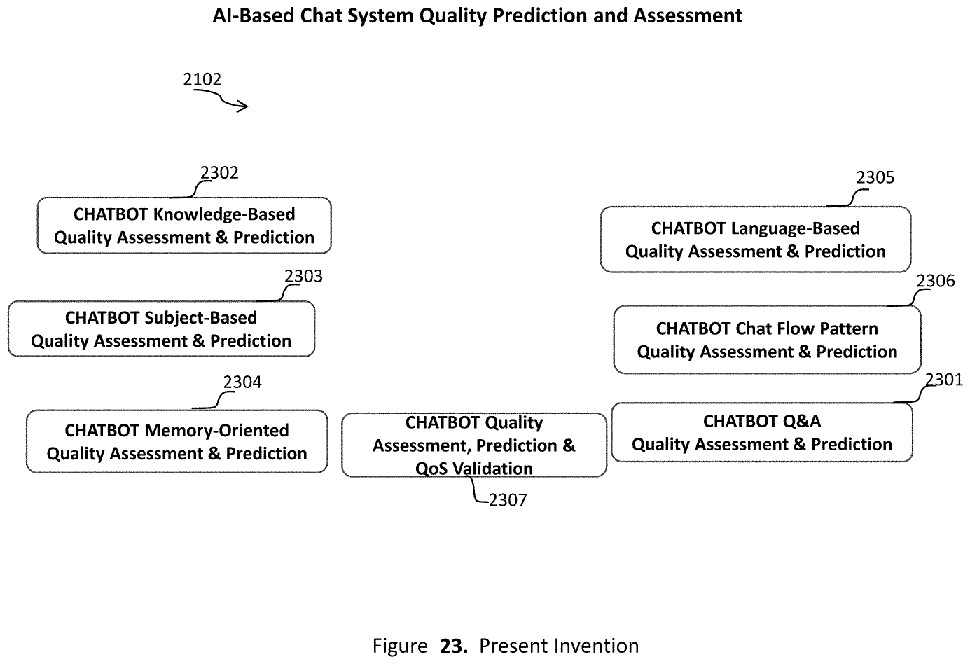

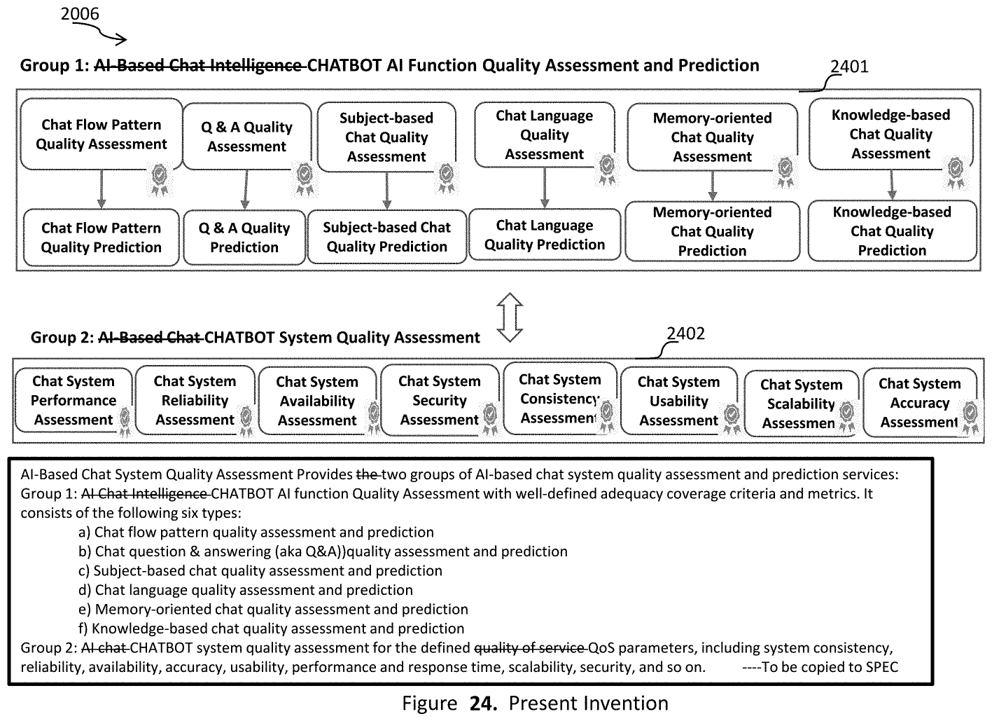

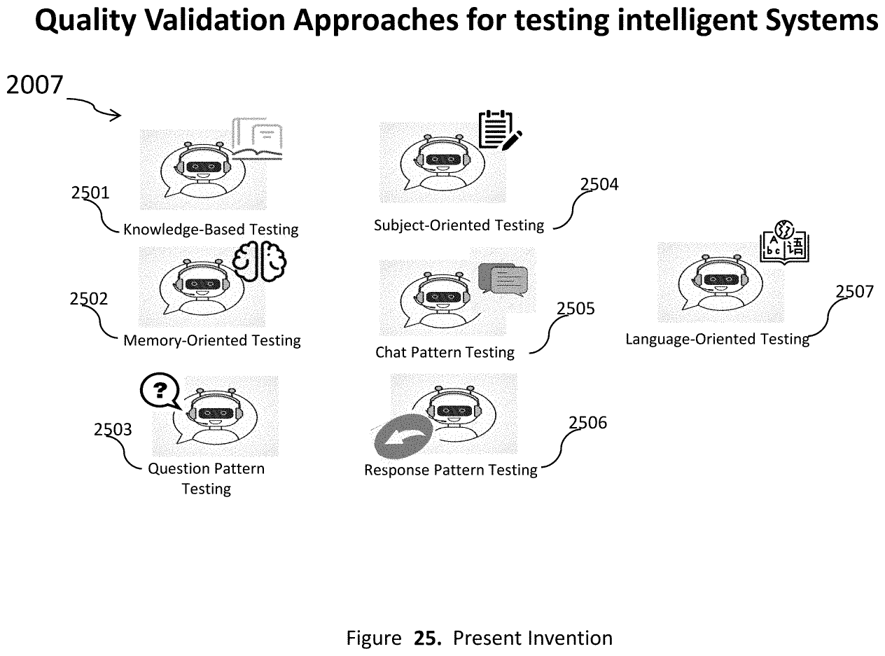

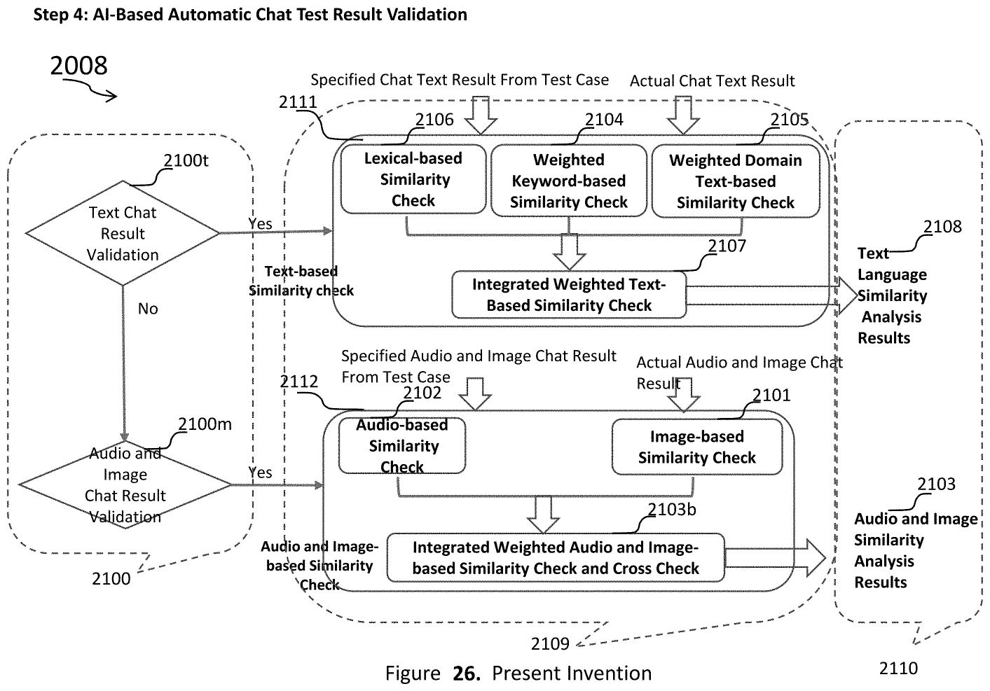

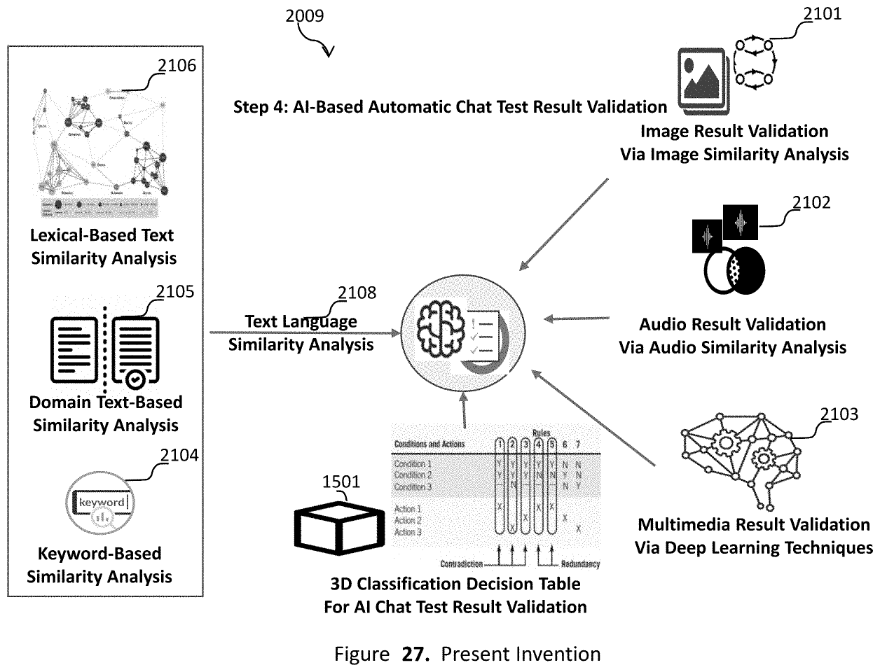

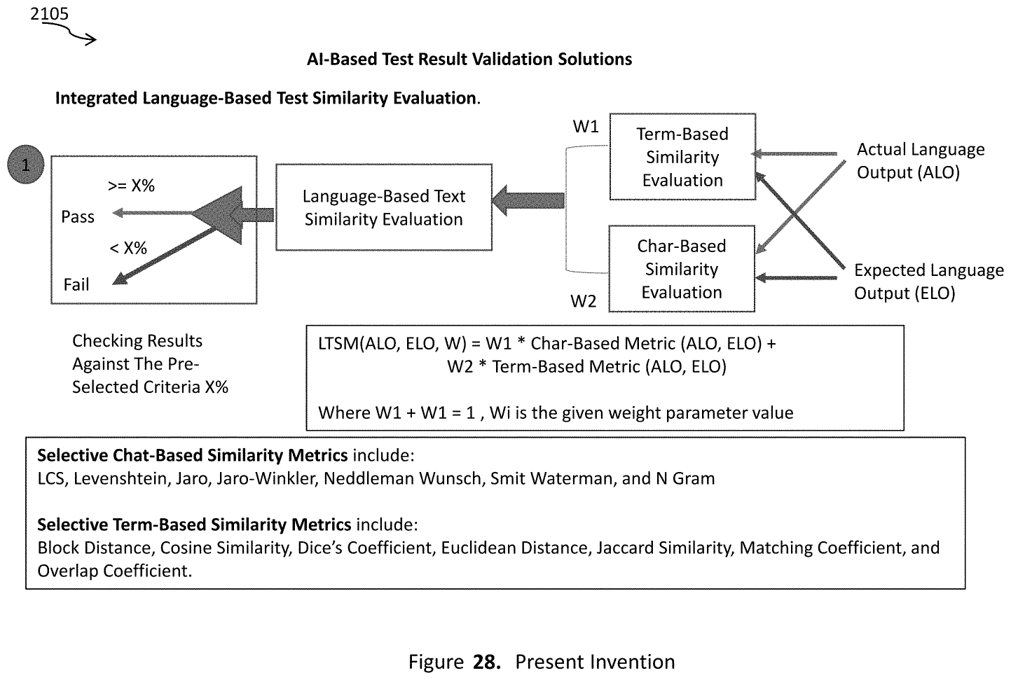

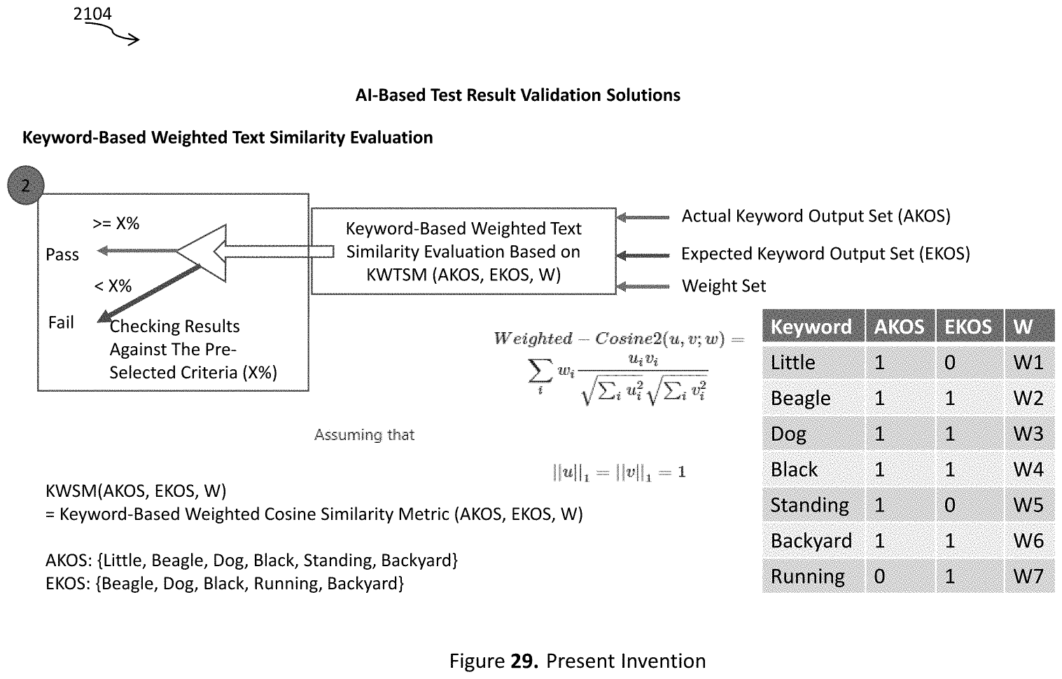

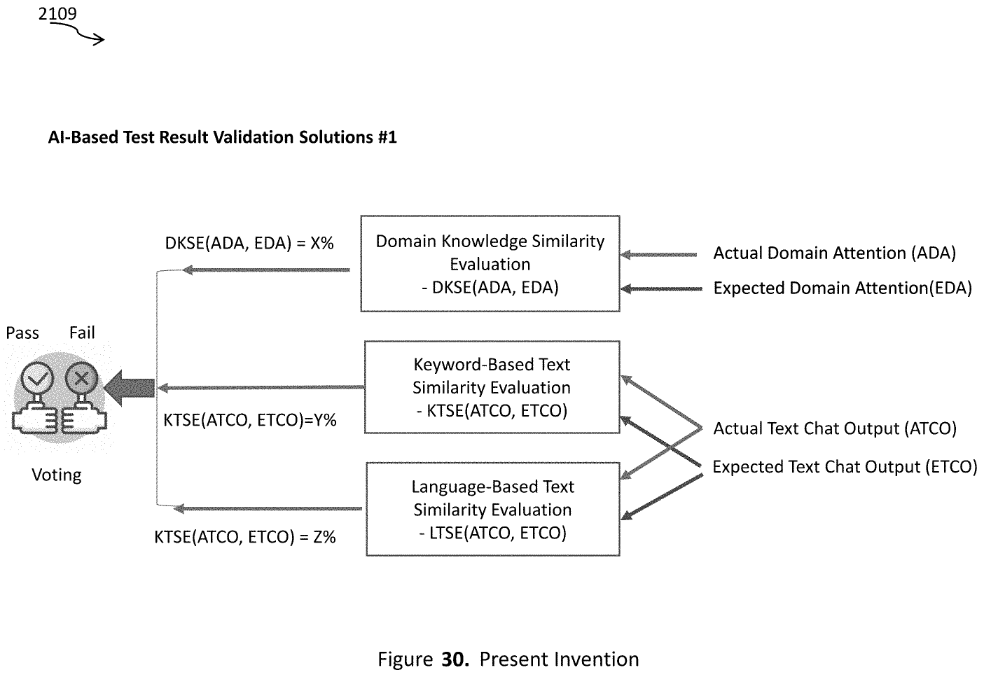

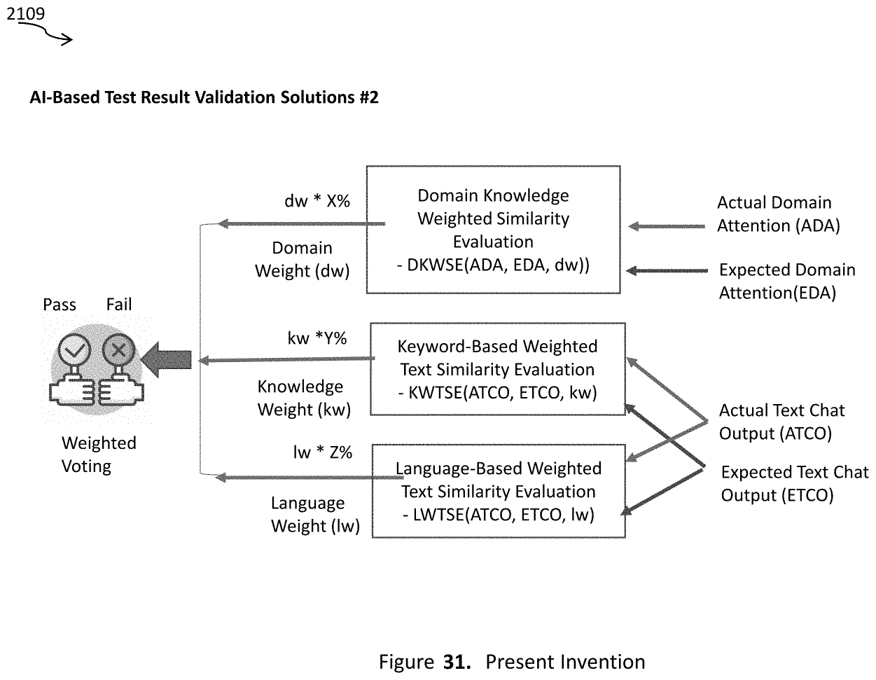

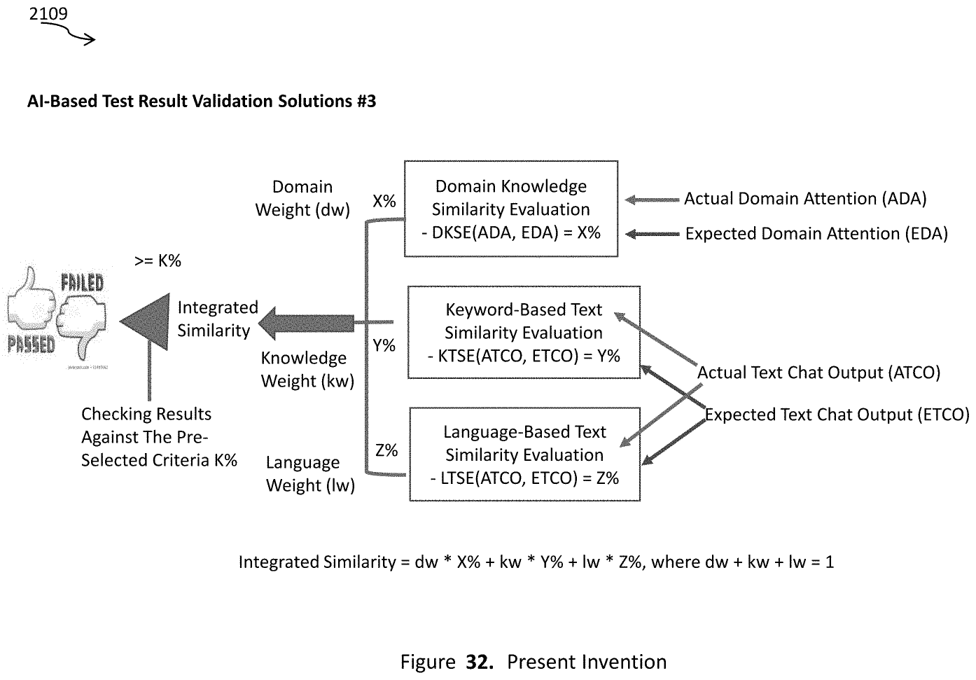

FIG. 19 illustrates a flow diagram of whole process of a classification-based automation for AI functions (1608). It includes six steps: automatic test planning and modeling (1901), automatic or semi-automatic test generation (1902), automatic test selection and execution (1903), automatic test quality assessment (1904), automatic re-test selection and generation (1905), automatic test execution and quality assessment (1906).
a. Steps 1 (1901): Automatic test planning and modeling includes model discovery, generation, and validation.
b. Step 2 (1902): Automatic or semi-automatic test generation includes test script generation, test case generation, and test data generation.
c. Step 3 (1903): Automatic test selection and execution process automatically select test script, control test execution, validate test result, and general problem/bug.
d. Step 4 (1904): Automatic test quality assessment process automatically analysis test model coverage and problem/bug quality.
e. Step 5 (1905): Automatic re-test selection & generation process automatically select, and general re-test script and general re-test cases.
f. Step 5 (1906): Automatic test execution and quality assessment process execute re-test script, analysis re-test converges, validate re-test result quality, and evaluate bug/problem quality.

### BACKGROUND

Organizations across various industry verticals are increasingly adopting AI to make more informed decisions. This provides enhanced customer service which is opening several new opportunities for market vendors. This growing trend not only provides very good business and research opportunities but also brings technical challenges and needs in testing and testing automation of an AI-based chat system (AICS), a.k.a. chatbot. As a special type of intelligent mobile apps, testing Chatbots encounters similar challenges and issues. Like intelligent/smart mobile apps, modern Chatbots have the following features:
Developed based on NLP and machine learning models utilizing big data
Rich-media inputs and outputs, text, audio, and images
Text-to-speech and speech-to-text functions
Text generation, synthesis, and analysis capabilities
Uncertainty and non-deterministic in response generation
Understanding selected languages and diverse questions and generating responses with diverse linguistic skills

These special features bring many issues and challenges in the quality testing and evaluation of Chatbots. Some work has presented literature reviews of evaluating Chatbots and numerous published papers have addressed some related issues and challenges, they lack a clear and comprehensive tutorial and taxonomy on testing Chatbots, including quality validation approaches, test models, quality standards and adequacy assessment criteria.

### PRESENT INVENTION

The present invention introduces a classification test model for testing intelligent chatbots. It supports testing design for the following types of chatbot testing.

### Testing Chatbots

1. Knowledge-based test modeling—Establish testing models focusing on selected domain-specific knowledge for a given chatbot to see how well it understands the received domain-specific questions and provides proper domain-related responses. An example given below illustrate one simple example of domain-specific knowledge classes. For service-oriented domain chatbots, we may consider diverse knowledge in products, services, programs, and customers.
2. Memory-oriented test modeling—Establish testing models for validating memory capability of a given chatbot to see how well it remembers users' profiles, questions, related chats, and interactions as well. The example shows one memory-oriented test model, including long-term and short-term memory classifications for testing design.
3. Language and Linguistics test modeling—Establish testing models for validating the language skills and linguistics diversity for a given chatbot. The example shows four aspects in test modeling for linguistics, including sentences, diverse lexical items, types of sentences, semantics, and syntax, with classification in each dimension.
4. Q&A pattern test modeling—Establish testing models for validating the diverse question and answer capability of a given chatbot to see how well it handles diverse questions from clients, and generates different types of responses. The example shows a reference classification model for different types of questions and answers.
5. Chat pattern test modeling—Establish testing models for validating diverse chat patterns for a given chatbot to see how well it handles diverse chatting patterns and interactive flows, with classification in each dimension. Some sequence flow patterns are given in
6. Subject-oriented test modeling—Establish testing models focusing on a selected conversation subject for a given chatbot to see how well it understands the questions and provides proper responses on diverse select subjects in Chatbots. Typical conversational subjects (subject classification) include travel, driving direction, sports, and so on.

### Adequacy of Quality Criteria for Testing Chatbots

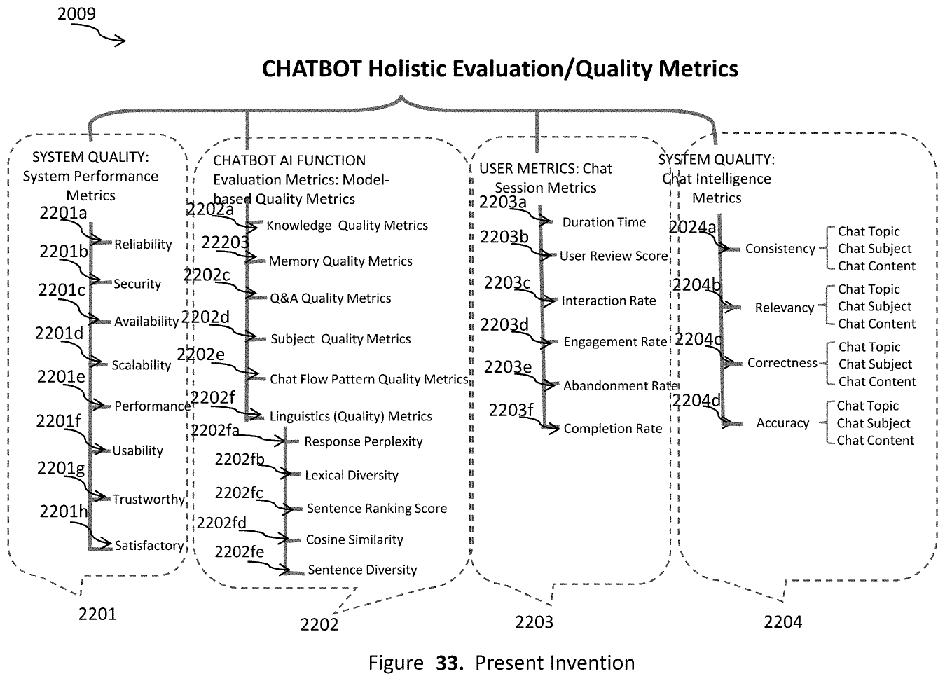

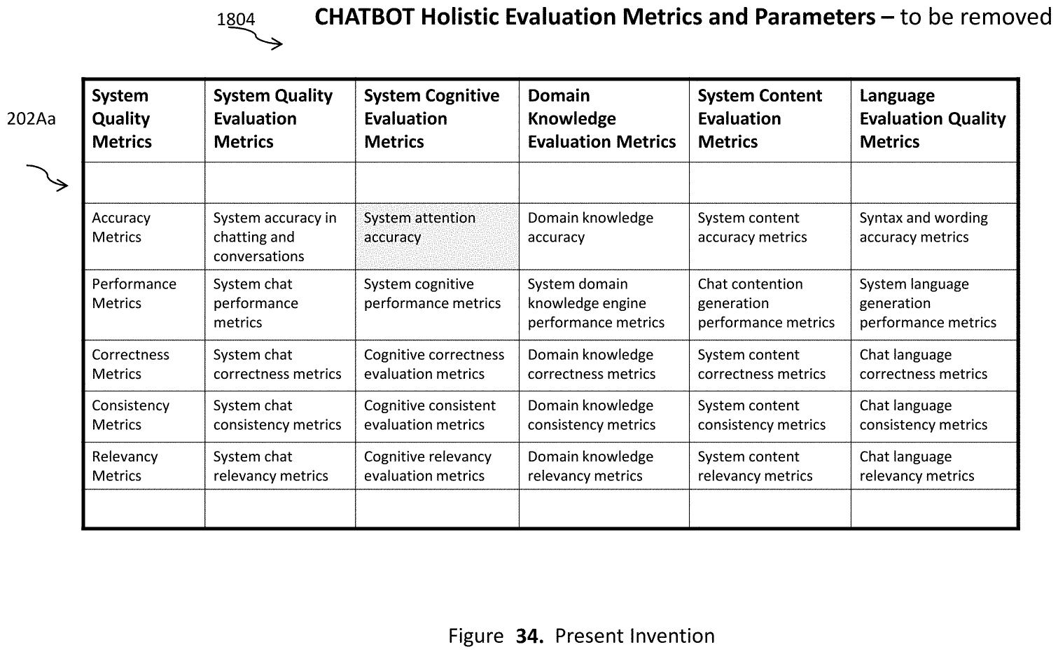

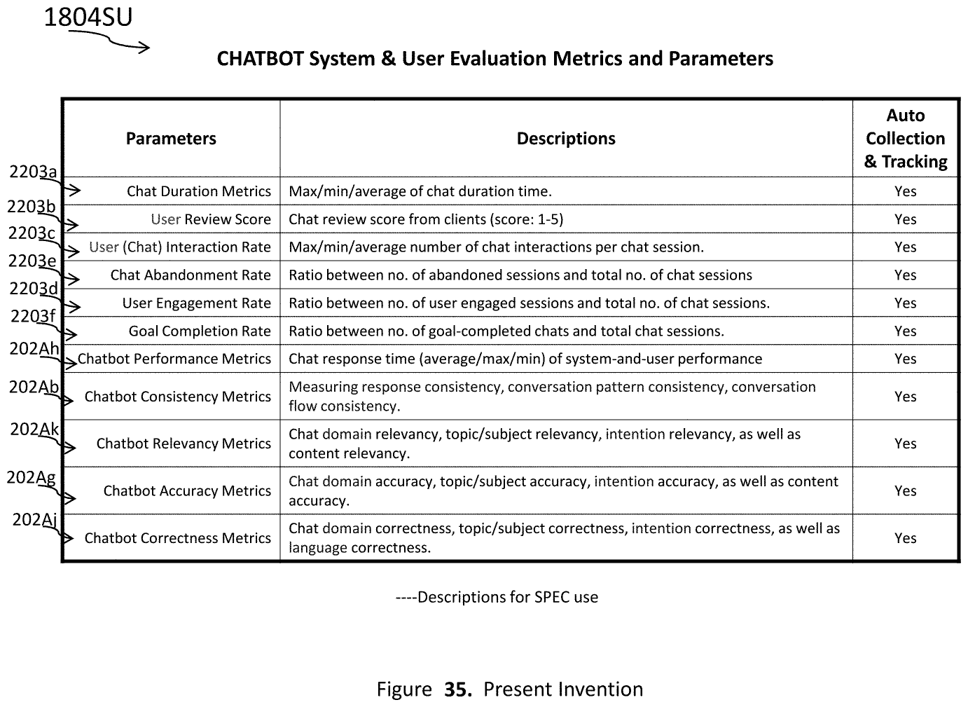

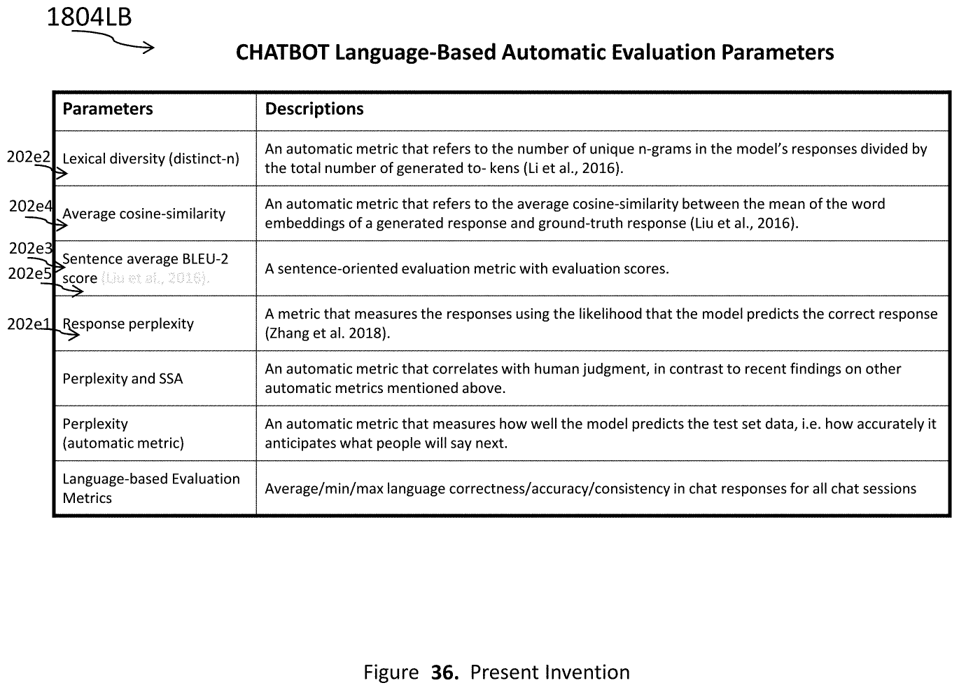

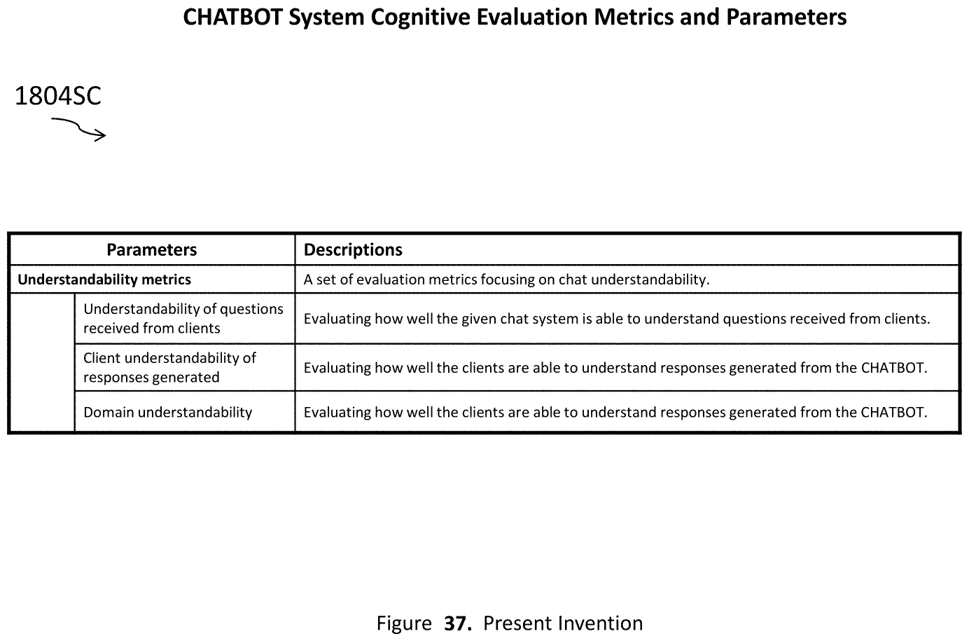

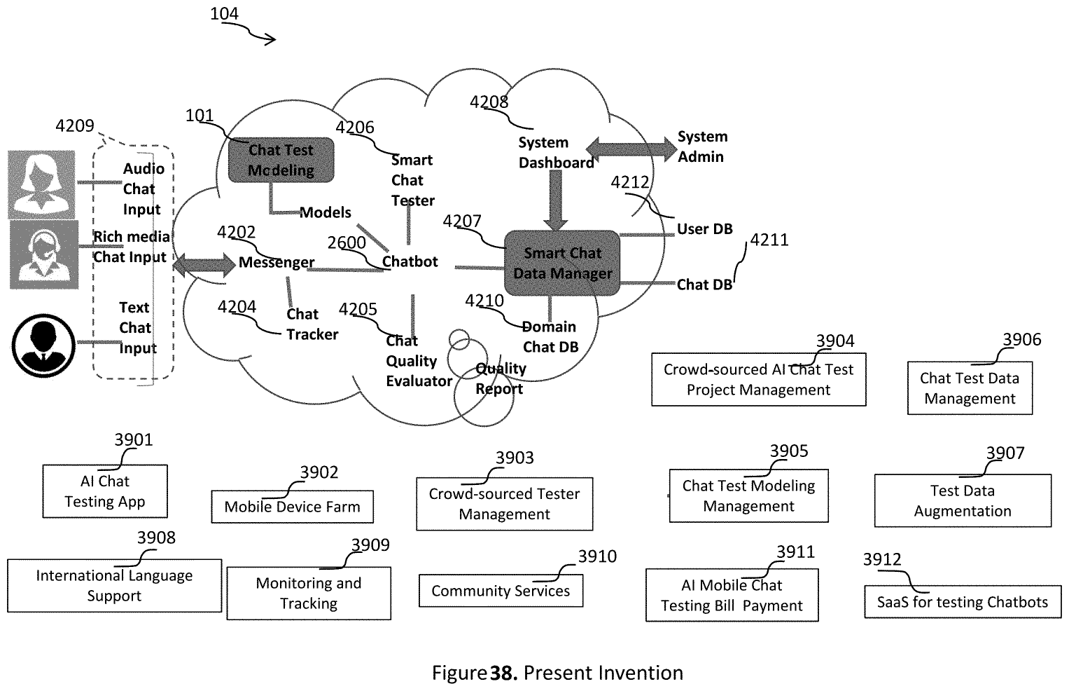

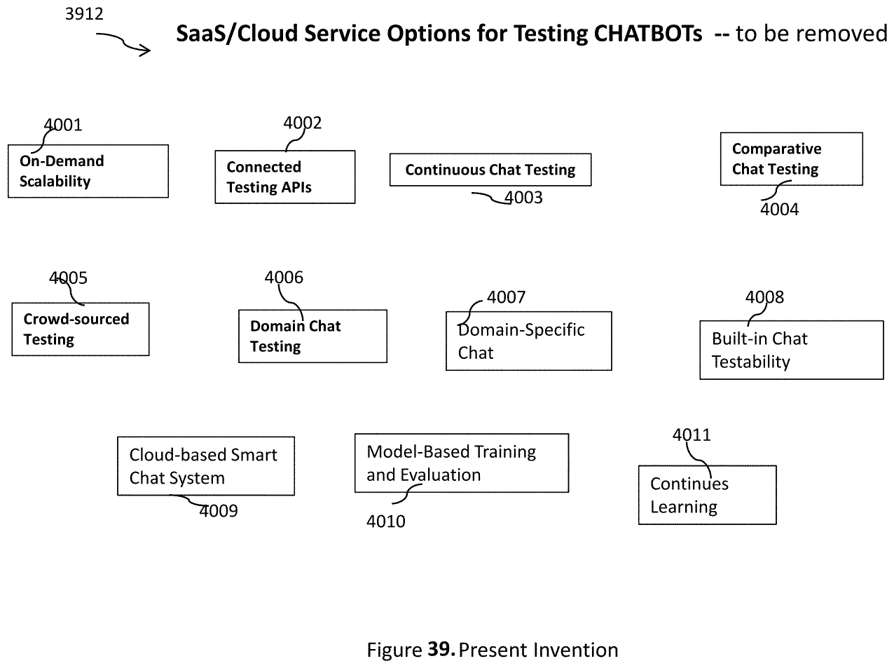

The FIGS. 33-34 illustrate the chatbot quality metrics from six aspects. Every aspect has different focuses to measure chat quality. Based on these metrics, we can establish different test adequacy criteria for a given chatbot below.
Domain Knowledge Test Criteria—Well-defined test criteria are needed to setup to address diverse domain knowledge test adequacy for Chatbots to make sure that chat tests are designed to address classified knowledge scope, topics, and domain-specific questions and answers. Based on our recent testing experience of diverse Chatbots, this must be critical and important test criteria for domain-specific Chatbots. Some examples provide some details for incorporating domain knowledge into data mining classifiers, which could be useful in establishing domain knowledge test criteria.
Chatting Memory Test Criteria—These test criteria are setup to check the memory capability for Chatbots to make sure that its classified chatting memory capability and perspectives are covered with classified tests. Typical customer-oriented Chatbots must remember user profiles, contacts, user cases, payment records, shipping addresses, past inquires, and user case progresses. For a domain-based or subject-based chatbot, it must remember users' chat topics, subjects, contents, and interactions. Clearly, Chatbots must be validated based on their pre-defined memory capabilities and requirements.
Language Linguistics Test Criteria—These test criteria are setup to address diverse language and linguistics test adequacy for Chatbots to make sure that each selected language and its classified linguistics perspectives are covered with classified tests, including diversity and similarity in language lexical, syntax, and semantics.
Intelligent Chat Q&A Test Criteria—These test criteria are setup to address the Q&A test adequacy for Chatbots to make sure that classified chatting question and answer patterns are covered with classified tests. For example, different types of questions and answers are needed. We could define validation criteria for different classes of questions, including
   “Word” questions, W-questions, idiom questions.
   Open-context, probing, leading, loaded, funnel, recall and process, and rhetorical questions.
   Open-end, specific, motivation, unconventional questions, and illegal questions.
   Different types of relating to knowledge concept, comprehension, application, analysis, evaluation, and synthesis.

Similarly, the Chatbots also need to deal with different types of questions and generate classified responses, including
Greeting, acknowledgment, verification, asking for details, canned responses, guiding step-by-step, and end chatting.
   Talking about prices, features, special offers, sending links, and product resources.
   Handling complaints, confused customers and trolls, mistakes, transferring, and putting on hold.
Chatting Subject Test Criteria—These test criteria are setup to address the test adequacy for diverse subject-oriented chat interactions for Chatbots to make sure that each selected subject and its classified perspectives are covered with classified tests.
Chatting Pattern Test Criteria—These test criteria are setup to check the capability of the pre-defined chatting flows, and/or diverse chatting patterns. When people and enterprises plan to use Chatbots to facilitate customer support, setting up or selecting this kind of test criteria is necessary to ensure that their pre-defined chatting flows and/or patterns are validated before deploying a-selected Chatbots.

### Platform for Testing Chatbots

The figures illustrate the infrastructure of the chatbot testing service platform.
Crowdsourced Tester Management is a test service that manages testers' information. This part contains a chat user DB, which is a rational DB and stores all signed user accounts and profiles.
Mobile Device Farm is an application testing service that helps test mobile applications on various real mobile devices, thereby improving the performance of these applications without the need to pre-set and manage any tests infrastructure. Users can simultaneously run tests on multiple real devices to speed up the execution of test suite and generate logs to quickly find application problems.
AI Chat Test App is a test service that manages all AI chat test applications on various mobile devices.
Chat Test Modeling Management can support the configuration, management, and maintenance of diverse AI chat testing models, such as knowledge test models, feature test models, object test models, and data test models.
Chat Test Data Management is a test service that efficiently enables secure and automated provisioning of chat test data, that may include test input and outcome data, based on test plan requirements. Testers can store, augment, share, and reuse test datasets to improve their efficiency in testing.
Data Augmentation is a test service that is used to increase the amount and diversity of data by adding slightly modified copies of already existing data or newly created synthetic data from existing data, such as synonym replacement, back translation, word insertion, etc.
Crowdsourced AI Chat Testing Project Management is a management platform that can manage projects under testing. Testers can upload, configure, and delete testing projects based on their testing requirements and plans. Then testers can run diverse AI chat tests based on generated test data including test input and outcome data and test scripts and report testing results.
AI Mobile Chat Testing Bill Payment provides a chat test payment service for users to transfer credit cards and checks through Internet electronic transactions.
Monitoring and Tracking is a testing service that tracks and monitors interactive chat sessions and keeps traces for testing and evaluation. Then it performs quality evaluation and analysis based on the provided chat quality validation criteria.

In addition to the services mentioned above, the chat test platform also provides community services for users to communicate with each other and support international language.

The testing service platform can equip a chatbot quality dashboard that supports interactions between clients and the chat system based on message service frameworks. As shown in the figures, a quality test process, and features for Chatbots consist of the following six steps:
Step 1: chatbot test modeling and analysis—Firstly, Testers should analyze the chatbot comprehensively, then define and establish quality models to support test case and data generation, chatbot testing and analysis, adequate validation QA standards, test coverage criteria as well as result validation.
Step2: chatbot testing data generation and test DB augmentation—The chatbot testing data generator can augment test DB based on testing requirements and store testing data into chatbot test DB including domain chat DB and big chat DB. Domain Chat DB consists of domain-specific chat data, including training, testing, and raw data (how about validation data?). Big Chat DB is a NoSQL big data DB, useful for discovering and learning chat knowledge and patterns.
Step3: chatbot test simulation and runner Chat test simulator and runner can mimic user utterances to chat with Chatbots in a life-like environment for assessing chat skills automatically.
Step4: chatbot tracking and validation—chatbot quality tracker keeps testing traces and evaluation to support continuously training, validation and improvement.
Step5: chatbot test coverage analysis and evaluation—This step computes test coverage and evaluates performance of intelligent chat by quality metrics.
Step6: chatbot QoS system validation and certification—The focus of this step is to verify and certify that chatbot QoS system specifications conform to needs and intended uses, and that the particular requirements can be consistently fulfilled.

The testing system/method establishes infrastructure of chatbot testing services (SaaS) comprising and enabling service components/modules of Crowdsourced chatbot Testing Project Management, Crowdsourced Tester Management, Mobile Device Farm w/chatbot Test App, Chat Test Data Management, Data Augmentation, Chat Test Modeling Management, Monitoring and Tracking, plus AI (Mobile) Chat Testing Bill Payment.

The testing system/method creates multi-perspective classification-based test models to formulate chatbot AI function space; establishes holistic chatbot testing scope for both AI function layer and system characteristic layer with chatbot-specific adequacy criteria via constructing multi-dimensional chatbot quality metrics and indicators for chatbot test validation; enables a systematic

AI-powered chatbot test automation process in cloud scale (i.e. SaaS) as an ultimate solution for testing chatbot; establishes step-wise chatbot quality test process utilizing the cloud infrastructure of chatbot test services (SaaS) which equip with chatbot quality dashboard and test database yielding chatbot QoS validation and certification.

The present invention aims at overcoming the following major problems in testing chatbots and enabling systematic testing process automation:

1. An AI-based method (100), realized by computer software recorded on a system of computer hardware, for testing an intelligent chatbot (108) comprising
a. a process of AI-based test modeling for testing intelligent chatbot(s) (101);
b. a process of AI-based automation for testing intelligent chatbot(s) (102);
c. a process of AI-based quality validation for intelligent chatbot(s) (103); and
d. a process of forming and running an AI-based platform for testing intelligent chatbot(s) (104).

2. The AI-based method (100) for testing an intelligent chatbot (108) of claim 1, wherein the process of AI-based test modeling (101) comprises
a. searching and discovering (201) test models;
b. creating (202) test models using an AI test tool if no test model is found by the previous step a;
c. collecting and classifying (203) the test model(s) if one or more test models is/are found by the previous step a;
d. analyzing and comparing test model similarity (204);
e. recommending test models (205);
f. customizing test models (206);
g. performing classification-based modeling (208); and
h. storing and managing test models (207).

3. The AI-based method (100) for testing an intelligent chatbot (108) of claim 2, wherein creating (202) test models using an AI test tool comprises
a. learning-based chat test modeling (301);
b. analyzing the intelligent chatbot and generating multi-perspective intelligence test models (303); and
c. generating core test data based on the multi-perspective intelligence test models and performing an AI-based augmentation on the core test data for generating augmented test data thus forming an enhanced test database combining both the core test data and the augmented test data (302).

4. The AI-based method (100) for testing an intelligent chatbot (108) of claim 1, wherein the process of AI-based automation (102) comprises
a. enabling a systematic AI-powered test automation process integrating the above steps;
b. collecting and tracking test results in rich media formats and validating chatbot test results using AI-based techniques;
c. automatically analyzing and evaluating intelligence test coverages based on the multi-perspective intelligence test models (105);
d. validating and certifying system quality of services (QOS) of the chatbot based on a set of QoS test scopes and parameters as a quality validation metrics (106); and
e. forming and running a cloud-based platform based on the above steps for testing chatbots in a large-scale (107).

5. The AI-based method (100) for testing an intelligent chatbot (108) of claim 5 wherein the step of classification-based modeling comprises steps of
a. generating a classification-based context perspective;
b. generating a classification-based input perspective; and
c. generating a classification-based output perspective.

6. The AI-based method (100) for testing an intelligent chatbot (108) of claim 5 wherein generating the classification-based input perspective comprises
a. knowledge-based test modeling;
b. memory-oriented test modeling;
c. linguistics test modeling;
d. Q&A pattern test modeling;
e. chat pattern test modeling; and
f. subject-oriented test modeling.

7. The AI-based method (100) for testing an intelligent chatbot (108) of claim 5 wherein generating the classification-based context perspective comprises
a. identifying context attributes; and
b. generating one or more context spanning tree(s).

8. The AI-based method (100) for testing an intelligent chatbot (108) of claim 5 wherein generating the classification-based output perspective comprises generating one or more output spanning tree(s).

9. The AI-based method (100) for testing an intelligent chatbot (108) of claim 2 wherein knowledge-based test modeling comprises
a. classifying and selecting a domain;
b. classifying and selecting domain-specific questions;
c. classifying and selecting domain-related responses; and
d. evaluating the domain-related responses to the domain-specific questions.

10. The AI-based method (100) for testing an intelligent chatbot (108) of claim 7 wherein memory-oriented test modeling comprises
a. classifying memory capacity into a long-term memory and short-term memory classifications; and
b. evaluating and validating the chatbot's memory capacity regarding users' profiles, past and current cases, inquires, responses, chat topics, and interactions.

11. The AI-based method (100) for testing an intelligent chatbot (108) of claim 7 wherein linguistics test modeling comprises
a. classifying linguistic diversity in dimensions of sentence, syntax, semantics, and lexical items;
b. evaluating and validating a chatbot's linguistics diversity in multi-dimensions;
c. classifying language(s); and
d. evaluating and validating the chatbot's language skills.

12. The AI-based method (100) for testing an intelligent chatbot (108) of claim 7 wherein Q&A pattern test modeling comprises
a. establishing question classes and responses classes;
b. evaluating and classifying types of chatbot's responses to diverse questions from users/clients of the chatbot; and
c. validating the chatbot's diverse question-answer capability.

13. The AI-based method (100) for testing an intelligent chatbot (108) of claim 7 wherein chat pattern test modeling comprises
a. a procedure of establishing chat sentence classes and chat pattern classes;
b. a procedure of evaluating and classifying an chatbot's diverse chatting patterns and interactive flows; and
c. a procedure of validating the chatbot's diverse chat patterns.

14. The AI-based method (100) for testing an intelligent chatbot (108) of claim 7 wherein the procedure of subject-oriented test modeling comprises
a. a procedure of subject matter classification and selection; and
b. a procedure of evaluating and validating an chatbot's responses to questions on diverse selection of subjects.

15. The AI-based method (100) for testing an intelligent chatbot (108) of claim 2 wherein generating test data based on the multi-dimension AI testing model and performing an AI test data augmentation for forming a chatbot test database (DB) comprises
a. a procedure of model-based test case generation;
b. a procedure of AI chat data discovery;
c. a procedure for AI chat testing data generator to augment test data based on testing requirements and store test data into the DB which comprises
1. domain chat DB comprises domain-specific training-test-validation chat data; and
2. big chat DB for chat knowledge learning and chat pattern discovery; and
d. a procedure of adding slightly modified copies of already existing data or newly created synthetic data from existing data, such as synonym replacement, back translation, word insertion, etc. to increase the amount and diversity of data.

16. The AI-based method (100) for testing an intelligent chatbot (108) of claim 4 wherein the procedure enabling a systematic AI-powered test automation process comprises
a. a procedure, relevant to test modeling, comprises
1. a procedure of generating diverse context configurations and conditions;
2. a procedure of generating classified chat outputs;
3. a procedure of generating perspective-specific classified chat inputs;
4. a procedure of chat test model discovery;
5. a procedure of similarity analysis; and
6. a procedure of model recommendation; and
b. a procedure, relevant to test generation, comprises
1. a procedure of (classification) model-based test generation;
2. a procedure of test data augmentation; and
3. a procedure of AI test scripting.

17. The AI-based method (100) for testing an intelligent chatbot (108) of claim 4 wherein the procedure of collecting and tracking test results in rich media formats and validating test results (responses of an intelligent chatbot) using AI-based techniques comprises
a. a procedure of tracking and monitoring interactive chat sessions;
b. a procedure of keeping traces for testing and evaluation;
c. a procedure of quality evaluation and analysis based on the provided chat quality validation criteria; and
d. a procedure of supporting continuous training, validation and improvement.

18. The AI-based method (100) for testing an intelligent chatbot (108) of claim 1 wherein the procedure of automatically analyzing and evaluating intelligence test coverages based on the multi-dimension intelligence testing model comprises
a. procedure of computing test coverage with relevant adequacy criteria; and
b. a procedure of evaluating the performance of a chatbot by quality metrics.

19. The AI-based method (100) for testing an intelligent chatbot (108) of claim 4 wherein the procedure of validating and certifying system quality of services (QOS) of the chatbot based on a set of QoS test scopes and parameters as a quality validation metrics comprises
a. a procedure of verifying and certifying that chatbot QoS system specifications of a chatbot conform to needs and intended uses; and
b. a procedure of verifying that particular intended requirements can be consistently fulfilled.

20. The AI-based method (100) for testing an intelligent chatbot (108) of claim 4 wherein the procedure of forming a cloud-based platform based on the above procedures for testing Chatbots in a large-scale comprises
a. A procedure of measuring and/or evaluating system scalability with respect to deployed cloud infrastructure, hosted platform, AIC application, large-scale chatting data volume, and user-oriented large-scale accesses;
b. a procedure of measuring and/or evaluating system availability with respect to its underlying cloud infrastructure, supporting platform environment, and targeted chat application SaaS/user-oriented chat SaaS;
c. a procedure of measuring and/or evaluating system security with respect to its underlying cloud infrastructure, supporting platform environment, client application SaaS, user authentication, and end-to-end chat sessions; and
d. a procedure of measuring and/or evaluating system reliability with respect to its underlying cloud infrastructure, deployed and hosted platform environment, and chat application SaaS.
